(19) United States
(12) Patent Application Publication
(10) Pub. No.: US 2026/0029233 A1
(43) Pub. Date: Jan. 29, 2026

(54) ROTATIONAL FLEXURE PIVOT

(71) Applicant: Raytheon Company, Arlington, VA (US)

(72) Inventor: Eric E-Lee Chang, Dallas, TX (US)

(21) Appl. No.: 19/271,097

(22) Filed: Jul. 16, 2025

Related U.S. Application Data
(60) Provisional application No. 63/674,444, filed on Jul. 23, 2024.

(51) Int. Cl. G01C 19/16

(52) U.S. Cl. CPC G01C 19/16

(57) ABSTRACT

Embodiments of the disclosure are directed to a structure operable to perform compensation movements. The structure includes a flexure system that includes an outer member (OM) flexure system associated with an outer member; and an inner member (IM) flexure system associated with an inner member. The OM flexure system includes OM flexures having first OM flexure endpoints, and the IM flexure system includes IM flexures having first IM flexure endpoints. The structure further includes a common flexure endpoint that includes the first IM flexure endpoints co-located with the first OM flexure endpoints. The IM flexures include a first IM flexure mechanically coupled to the inner member, and the OM flexures include a first OM flexure mechanically coupled to the outer member. The compensation movements include the inner member and the outer member moving with respect to one another.

### CROSS-REFERENCE TO RELATED APPLICATIONS

This application claims the benefit of U.S. Provisional Application No. 63/674,444 filed Jul. 23, 2024, the disclosure of which is incorporated herein by reference in its entirety.

### BACKGROUND

The present disclosure relates in general to the field of mechanics and more specifically to fabrication methods, use methods and structures for a novel flexural pivot operable to impart fine positional adjustments to an object or device in order to stabilize a line of site (LOS) from the object/device (e.g., a sensor) to a target. The present disclosure further relates to additive manufacturing operations for fabricating the novel flexural pivot.

In combat or other information gathering situations, a sensor package or other object/device mounted on a vehicle or vessel in motion can be used to obtain location or other information about the environment or an identified target. Alternatively, the object/device can be used to sight on the target for long-range firing or other purposes. Accordingly, the sensor package or other object/device can establish a LOS with the identified target, which can be located some distance from the sensor package or other object/device, or another generally horizontal field.

While the information is being obtained or weaponry is being engaged, the LOS directed at the identified target must be maintained. Such sensor packages and objects/device, however, are typically supported on a moving vehicle, aircraft, or other carrier. As the supporting machinery moves along the uneven surface of the ground, air, or sea, changes in pitch, roll, or elevation can cause the LOS with the identified target or other horizontal field to be broken if the resulting change in the position of the sensor or other object/device is not compensated for.

Typical sensors and other objects/devices are mounted with gimbal systems that operate to adjust the position of the sensor package or other object/device along two or more axes. In such gimbal systems, the mounting system of the gimbal typically includes an inner structure that encircles or at least partially encircles the sensor package or other object/device. Each of the two or more degrees of freedom provided by the gimbal are orthogonal to each other and operate independently of every other axis.

Gimbal systems can be provided with fine-compensation components operable to implement relatively fine rotational adjustments that are needed in order assist the above-described sensor package with establishing and/or maintaining a LOS with the identified target. Such fine-compensation components can be implemented as so-called “flexural pivots,” which are devices that permit mechanical members to pivot about a common axis relative to each other through a limited angle range. Because angular motion is accomplished through flexing of elastic flexural elements, rather than contact surface displacement, flexural pivots operate without friction and thus without a need for lubrication. Flexural pivots can therefore be a substitute for bearings in applications where friction and/or the need for lubrication are concerns.

A variety of flexural pivots are commercially available for a variety of applications. Common problems with commercial off-the-shelf (COTS) flexural pivots are repeatable performance and reliability, particularly where high performance and durability are required for the application. This can be due to, for example, the overall relatively high complexity of known COTS flexural pivot designs, the relatively large number of components in known COTS flexural pivot designs, and the difficulty in manufacturing and/or fabricating such known COTS flexural pivots in a commercially viable manner. Thus, it is desirable to develop a flexural pivot design that provides high performance and reliability while being relatively simple and cost-effective to produce.

### SUMMARY

Embodiments of the disclosure are directed to a structure operable to perform compensation movements. The structure includes a flexure system that includes an outer member (OM) flexure system associated with an outer member; and an inner member (IM) flexure system associated with an inner member. The OM flexure system includes OM flexures having first OM flexure endpoints, and the IM flexure system includes IM flexures having first IM flexure endpoints. The structure further includes a common flexure endpoint that includes the first IM flexure endpoints co-located with the first OM flexure endpoints. The IM flexures include a first IM flexure mechanically coupled to the inner member, and the OM flexures include a first OM flexure mechanically coupled to the outer member. The compensation movements include the inner member and the outer member moving with respect to one another.

In addition to any one or more of the features described herein, the compensation movements include a rotation.

In addition to any one or more of the features described herein, the outer member includes an OM cavity; the inner member includes an IM cavity; and the inner member is at least partially within the OM cavity.

In addition to any one or more of the features described herein, the inner member includes an IM platonic shape having corners.

In addition to any one or more of the features described herein, the corners includes a first IM corner; and the first IM flexure is mechanically coupled to the inner member at the first IM corner.

In addition to any one or more of the features described herein, the outer member includes an OM substantially spherical shape having an OM inner surface and OM openings extending through the OM inner surface.

In addition to any one or more of the features described herein, the OM inner face includes a first OM inner face region; and the first OM flexure is mechanically coupled to the outer member at the first OM inner face region.

In addition to any one or more of the features described herein, the structure includes a no-movement position and movement positions.

In addition to any one or more of the features described herein, the no-movement position is based at least in part on: no movement force applied to the structure; substantially no bending in the OM flexures; and substantially no bending in the IM flexures. Additionally, the movement positions are based at least in part on: a movement force applied to the structure; bending in the OM flexures; and bending in the IM flexures.

In addition to any one or more of the features described herein, the outer member includes at least one OM opening extending through the output member; and the movement positions are restricted by the at least one OM opening.

Embodiments of the disclosure are further directed to a structure operable to perform compensation movements. The structure including an outer member including a substantially spherical shape and an OM cavity. The structure further includes an inner member including a substantially platonic shape having IM corners, along with an IM cavity. The inner member is at least partially within the OM cavity. The compensation movements include the inner member and the outer member moving with respect to one another. The structure further includes a flexure system including an OM flexure system mechanically coupled to the outer member, along with an IM flexure system mechanically coupled to the inner member. The OM flexure system includes OM flexures having first OM flexure endpoints. The IM flexure system includes IM flexures having first IM flexure endpoints, along with a common flexure endpoint including the first IM flexure endpoints co-located with the first OM flexure endpoints. The OM flexures include a first OM flexure. The OM flexure system mechanically coupled to the outer member includes the first OM flexure mechanically coupled to the outer member. The IM corners include a first IM corner. The IM flexures include a first IM flexure. The IM flexure system mechanically coupled to the inner member includes the first IM flexure mechanically coupled to the first IM corner.

In addition to any one or more of the features described herein, the compensation movements include a rotation.

In addition to any one or more of the features described herein, the substantially spherical shape includes an OM inner face and OM openings extending through the OM outer member.

In addition to any one or more of the features described herein, the OM inner face includes a first OM inner face region; and the first OM flexure is mechanically coupled to the outer member at the first OM inner face region.

In addition to any one or more of the features described herein, the structure includes a no-movement position and movement positions. The no-movement position is based at least in part on no movement force applied to the structure; substantially no bending in the OM flexures; and substantially no bending in the IM flexures. The movement positions are based at least in part on a movement force applied to the structure; bending in the OM flexures; and bending in the IM flexures. The outer member includes at least one OM opening extending through the output member. The movement positions are restricted by the at least one OM opening.

Embodiments of the disclosure are also directed to methods of use, along with fabrication method (including additive manufacturing methods), of the structures described herein.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a simplified block diagram illustrating a carrier system having a gimbal and a fine-compensation structure in accordance with embodiments of the disclosure;

FIG. 2 depicts a simplified diagram illustrating pitch, roll and yaw rotational axes used in accordance with embodiments of the disclosure;

FIG. 3 depicts a simplified diagram illustrating an isometric view of the fine-compensation structure of FIG. 1 implemented as a novel flexure pivot structure in accordance with embodiments of the disclosure;

FIG. 4A depicts a simplified diagram illustrating an isolated isometric view of a flexure system of the novel flexure pivot structure shown in FIG. 3;

FIG. 4B depicts a simplified diagram illustrating another isolated isometric view of the flexure system of the novel flexure pivot structure shown in FIG. 3;

FIG. 4C depicts a simplified diagram illustrating isolated isometric views of outer member (OM) flexures and inner member (IM) flexures of the flexure systems shown in FIGS. 4A and/or 4B;

FIG. 5A depicts a simplified diagram illustrating an isolated isometric view of an inner member of the novel flexure pivot structure shown in FIG. 3;

FIG. 5B depicts simplified diagrams illustrating non-limiting examples of substantially platonic shapes that can be used to implement the inner member shown in FIG. 5A;

FIG. 6A depicts a simplified diagram illustrating an isolated isometric view of an outer member of the novel flexure pivot structure shown in FIG. 3;

FIG. 6B depicts simplified diagrams illustrating non-limiting examples of substantially spherical shapes that can be used to implement the outer member shown in FIG. 6A;

FIG. 6C depicts a simplified diagram illustrating additional details of a non-limiting example of a substantially spherical shape that can be used to implement the outer member shown in FIG. 6A;

FIG. 6D depicts a transmissibility response plot illustrating vibration isolation functionality of embodiments of the disclosure;

FIG. 6E depicts a non-limiting example of how one or more OM flexures can be coupled to the OM in accordance with aspects of the disclosure;

FIG. 6F depicts a cut-away view of the OM flexure coupled to the OM shown in FIG. 6E;

FIG. 6G depicts a non-limiting example of how one or more OM flexures can be coupled to the OM in accordance with aspects of the disclosure;

FIG. 6H depicts a cross-sectional view of a serpentine, extra-compliance structure that can be incorporated into the OM to provide extra compliance thereto;

FIG. 7A depicts a simplified diagram of the novel flexure pivot structure shown in FIG. 3 and a line A-A that is used for the cross-sectional views of the novel flexure pivot structure shown in FIGS. 7B and 7C;

FIG. 7B depicts a simplified diagram illustrating the novel flexure pivot structure shown in FIG. 7A taken along Line A-A with no OM/IM rotation and no flexure bending;

FIG. 7C depicts a simplified diagram illustrating the novel flexure pivot structure shown in FIG. 7A taken along Line A-A with OM/IM rotation and associated flexure bending;

FIG. 8A depicts a simplified diagram illustrating the novel flexure pivot structure shown in FIG. 3 and a line B-B that is used for the cross-sectional view of the novel flexure pivot structure shown in FIG. 8B;

FIG. 8B depicts a simplified diagram illustrating the novel flexure pivot structure shown in FIG. 8A taken along Line B-B with OM/IM rotation and associated flexure bending;

FIG. 9A depicts a simplified diagram illustrating the novel flexure pivot structure shown in FIG. 3 and a line C-C that is used for the cross-sectional view of the novel flexure pivot structure shown in FIG. 9B;

FIG. 9B depicts a simplified diagram illustrating the novel flexure pivot structure shown in FIG. 9A taken along Line C-C with OM/IM rotation and associated flexure bending;

FIG. 9C depicts a simplified diagram illustrating the novel flexure pivot structure shown in FIG. 3 and a line D-D that is used for the cross-sectional view of the novel flexure pivot structure shown in FIG. 9D;

FIG. 9D depicts a simplified diagram illustrating the novel flexure pivot structure shown in FIG. 9C taken along Line D-D, which depicts longitudinal translation of the IM with respect to the OM;

FIG. 9E depicts a simplified diagram illustrating the novel flexure pivot structure shown in FIG. 3 and a line D-D that is used for the cross-sectional view of the novel flexure pivot structure shown in FIG. 9F;

FIG. 9F depicts a simplified diagram illustrating the novel flexure pivot structure shown in FIG. 9E taken along Line D-D, which depicts vertical translation of the IM with respect to the OM;

FIG. 10A depicts a simplified diagram illustrating an isometric view of a non-limiting example of how the gimbal structure of FIG. 1 can be implemented in accordance with embodiments of the disclosure;

FIG. 10B depicts a simplified diagram illustrating an isometric cutaway view of the gimbal structure shown in FIG. 10A;

FIG. 10C depicts a simplified diagram illustrating isolated components of the gimbal structure shown in FIG. 10B;

FIG. 10D depicts a simplified diagram further illustrating isolated components of the gimbal structure shown in FIG. 10C;

FIG. 10E depicts a simplified diagram further illustrating isolated components of the gimbal structure shown in FIG. 10A;

FIG. 10F depicts a simplified diagram further illustrating is isometric cutaway view of the isolated components of the gimbal structure shown in FIG. 10E;

FIG. 10G depicts an expanded view of the isometric cutaway view of the isolated components of the gimbal structure shown in FIG. 10F;

FIG. 11 depicts a simplified block diagram illustrating a fabrication and control system in accordance with embodiments of the disclosure;

FIG. 12 depicts a combined system diagram and flow diagram illustrating a printing device and a computer-controlled fabrication method in accordance with embodiments of the disclosure; and

FIG. 13 depicts a simplified block diagram illustrating a computing system operatable to perform various computer-control operations in accordance with embodiments of the disclosure.

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter.

Embodiments of the disclosure provide fabrication methods, use methods and structures for a novel flexural pivot operable to impart fine positional adjustments to an object in order to stabilize a line of site (LOS) from the object (e.g., a sensor) to a target. In some embodiments of the disclosure, the materials, functions, and design of the various components of the novel flexural pivot lend themselves to convenient fabrication using additive manufacturing techniques. The novel flexural pivot provides fine compensation movements (e.g., rotational movement in the range from about zero (0) degrees to about five (5) degrees) to a gimbal structure that is used to stabilize an LOS from a device (e.g., a sensor integrated into the gimbal) to a target. The novel flexural pivot is constructed in a manner that allows for rotational degrees of freedom of a receiver component of the gimbal around a common endpoint in any direction, but the novel flexural pivot is further constructed in a manner that does not allow the flexural pivot to translate.

In some embodiments of the disclosure, the novel flexural pivot includes three components, namely, a flexure system, an inner member having an inner member (IM) shape, and an outer member having an outer member (OM) shape. In some embodiments of the disclosure, the novel flexure pivot can include more than one inner member and/or more than one outer member. The OM shape defines an OM cavity, the IM shape defines an IM cavity, and the inner member is at least partially positioned within the OM cavity. The flexure system is positioned at least partially within the IM cavity, further extends at least partially into the OM cavity, and includes first and second sets of elongated flexures. The first set of elongated flexures of the flexure system forms an IM flexure system, and the second set of elongated flexures of the flexure system forms an OM flexure system. Each of the individual elongated flexures of the IM flexure system and the OM flexure system has two termination ends and terminates in two of three locations. A location where all of the individual elongated flexures of the IM flexure system and the OM flexure system terminate is a common flexure endpoint; a location where all of the individual elongated flexures of the IM flexure system terminate is at the inner member, and a location where all of the individual elongated flexures of the OM flexure system terminate is at the outer member. The inner member and the outer member are operable to allow rotational movement of the inner member with respect to the outer member, and this rotation is enabled by application of movement forces to the inner member and/or the outer member, along with an ability of the individual flexures of the IM flexure system and the OM flexure system to bend in response to the application of the movement forces to the inner member and/or the outer member. The IM flexure system and the OM flexure system are further configured and arranged to allow some translational movement of inner member and the outer member within the gimbal structure.

In some embodiments of the disclosure, the IM shape is a substantially platonic shape (e.g., a square or a cube) having IM corners and IM openings; and the OM shape is substantially spherical or a higher order platonic shape and includes OM openings. The individual elongated flexures of the IM flexure system can be configured to connect to the inner member at a corresponding one of the IM corners; and the individual flexures of the OM flexure system can be configured to connect to the outer member by passing through one of the IM openings and connecting to an inner surface of the outer member. In some embodiments of the disclosure, the inner member is positioned within the OM cavity such that the OM corners fit at least partially within a corresponding one of the OM openings. In some embodiments of the disclosure, the inner member is further positioned within the OM cavity such that rotation of the inner member and the outer member with respect to one another is limited by the ability of each of the IM corners to move within its corresponding OM opening.

In some embodiments of the disclosure, the novel flexural pivot is coupled to a gimbal structure that is coupled to a carrier (e.g., a vehicle). In some embodiments of the disclosure, the gimbal structure is a two-axis gimbal having a receiver element and a gimbal element. The receiver element is operable to house an object or device (e.g., a sensor), couple to the outer gimbal element, and be rotated by the outer gimbal element around a first axis and/or a second axis. For the first axis, the outer gimbal element is operable to rotate around the first axis, which also rotates the inner receiver element and the object/device being held by the inner receiver element around the first axis. For the second axis, the outer gimbal element is operable to rotate the inner receiver element around the second axis, which also rotates the inner receiver element and the object/device being held by the inner receiver element around the first axis.

The novel flexural pivot is positioned within an inner receiver cavity of the inner receiver element. The novel flexural pivot is physically coupled to the inner receiver element by physically coupling the inner member to an inner wall of the inner receiver cavity. The novel flexural pivot is physically coupled to the outer gimbal element by an outer gimbal element coupling structure that includes a first outer gimbal coupler; a second coupler of the outer member; a first elongated flexure of the OM flexure system; the common flexure endpoint; a second elongated flexure of the OM flexure system, a first coupler of the outer member; and a second outer gimbal coupler. The above-described coupling of the novel flexural pivot to the inner receiver element and the outer gimbal element allows relatively small translational movement of the novel flexural pivot within the inner receiver cavity and enables rotational movement of the inner member with respect to the outer member within the inner receiver element cavity. The rotational movement of the inner member with respect to the outer member within the inner receiver element cavity is initiated by applying a movement force through the above-described outer gimbal element coupling structure and the flexure systems to the inner member, which rotates the inner receiver element to which the inner member is physically coupled. In accordance with embodiments of the disclosure, the rotational movement applied to the inner member with respect to the outer member is a fine compensation rotational movement. In some embodiments of the disclosure, the fine compensation movement is a rotation between about zero (0) degrees and about five (5) degrees.

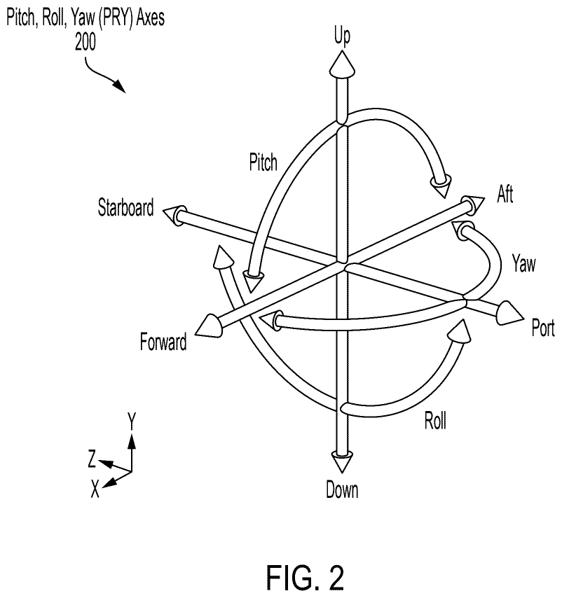

Accordingly, the above-described novel flexure pivot relies on bending of the individual elongated flexures to allow for rotation. The individual elongated flexures also act as translational stiffness because any translation load will be acted through the compression or tension through the axis of the above-described outer gimbal element coupling structure. Thus, the novel flexure pivot can be used to execute very small rotation displacements of the inner receiver element to allow for fine-elevation (elevation=the Up and Down directions shown in FIG. 2) and cross-elevation rotational position control. The central location of the common endpoint allows for additional length of the individual elongated flexures of the flexure system, which allows for additional bending length and therefore reduction in bending moment at the ends of the flexures compared to known flexure designs. The connection of the IM flexures at the corner regions of the inner member allows less bending of individual elongated flexures in order to achieve the desired rotation of the inner member and the inner receiver to which the inner member is coupled.

The novel flexure pivot can be formed from material types (e.g., steel, titanium, various polymers, and the like) that enable the novel flexural pivot to be fabricated using additive manufacturing techniques. Additive manufacturing will allow for the geometry of the novel flexure pivot to be achieved without having to meet the geometric constraints that currently exist with using machining and wire electrical discharge machining. Three-dimensional (3D) printing technology, also known as additive manufacturing, refers to a machine that fabricates a 3D physical object by using a printhead to successively form or deposit layers of material that will form a 3D physical object. The printhead operations are controlled by a computer that contains a 3D electronic model of the physical object. The 3D electronic model logically slices the physical object into several layers and provides instructions to the printhead for printing each layer. The instructions control the machine, and more specifically the printhead of the machine, to form/deposit each layer successively until the physical object is completed. The physical objects fabricated through 3D printing processes have a variety of shapes and geometries.

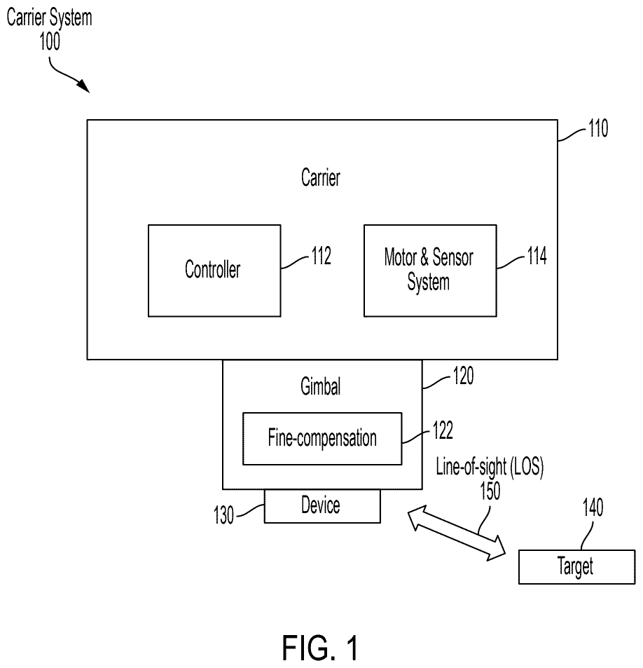

Turning now to a more detailed description of the aspects of the present disclosure, FIG. 1 depicts a simplified block diagram illustrating a carrier system 100 having a carrier 110 coupled to a gimbal 120 that includes a fine-compensation structure 122 in accordance with embodiments of the disclosure. FIG. 2 depicts a simplified diagram or graph illustrating pitch, roll and yaw (PRY) rotational axes 200 traversed by the gimbal 120 (shown in FIG. 1) and/or the fine-compensation structure 122 (shown in FIG. 1). Referring now to FIG. 1, the carrier system 100 includes the carrier 110 operable to include a controller 112, a motor & sensor system 114, and the gimbal 120, configured and arranged as shown. The gimbal 120 houses the fine-compensation structure 122 and a device 130.

The device 130 can be any structure that interacts wirelessly through a line-of-sight (LOS) 150 with a target 140, including, for example mirrors, still cameras, video cameras, sensors, and other direction-sensitive equipment. The carrier 110 can be any structure suitable for supporting and/or carrying the gimbal 120 and the device 130, and further suitable for the application to which the device 130 is applied. For example, where the device 130 is implemented as a video camera, the carrier 110 can be a camera dolly, a smartphone, and the like. Where the device 130 is implemented as a target detection sensor device, the carrier can be a wide variety of vehicle types, including, but not limited to, automobiles, trucks, motorcycles, busses, boats, airplanes, helicopters, unmanned aerial vehicles (UAVs), ships, boats, lawnmowers, recreational vehicles, amusement park vehicles, farm equipment, construction equipment, trams, golf carts, trains, and trolleys.

In simple terms, the gimbal 120 is a pivoting platform that allows the device 130 to rotate around one or more axes to stabilize the device 130 during operation thereof. In other words, instead of being fixed to an unmoving base, the device 130 mounted to or on the gimbal 120 can rotate along at least one axis. In the world of aeronautics, these axes are the pitch, roll, and yaw (PRY) rotational axes 200 shown in FIG. 2. The gimbal 120 is operable to, under control of the controller 112 and the motor & sensor system 114, rotates around the PRY rotational axes 200 to counter any rolling, pitching, or yawing motions that occur. FIG. 2 depicts a graph illustrating the PRY rotational axes 200 around which the gimbal 120 can rotate. The gimbal 120 can be configured and arranged to counteract the shakes and shudders in the device 130 when the carrier 110 moves the device 130 around the pitch, roll, or yaw axes 200. As shown in FIG. 2, the pitch axis (also known as the tilt axis) is the up and down movement of the device 130. When the carrier 110 tilts the device 130 from up to down to follow a falling object, for example, that is a movement around the pitch axis. The roll axis is the movement that feels like a boat rocking on the ocean. Left-to-right movement happens around the yaw or pan axis. Left-to-right (aft-to-forward) movement is used to capture targets 150 that move horizontally.

Because the carrier 110 is often a moving device (e.g., a moving vehicle, aircraft, or other carrier), while the device 130 is gaining information from or about the target 140, the gimbal 120 is controlled to perform movements that counter movements by the carrier 110 and maintain the LOS 150 directed at the identified target 140. As the carrier 110 moves along the uneven surface of the ground, air, or sea, changes in pitch, roll, or elevation can cause the LOS 150 with the identified target 140 to be broken if the resulting change in the position of the device 130 is not compensated for by the gimbal 120.

The gimbal 120 can be configured and arranged to adjust the position of the device 130 along two or more axes. In such an implementation of the gimbal 120, the mounting systems of the gimbal 120 is typically an inner structure that encircles or at least partially encircles the device 130. Each of the two or more degrees of freedom provided by the gimbal 120 are orthogonal to each other and operate independently of every other axis.

The gimbal 120 is provided with the fine-compensation structure 122 operable to implement relatively fine rotational adjustments that are needed in order assist the gimbal 120 with establishing and/or maintaining the LOS 150 with the identified target 140. The fine-compensation structure 122 can be implemented as a novel design of a so-called “flexural pivot” structure. In general, flexural pivots are devices that permit mechanical members to pivot about a common axis relative to each other through a limited angle range. Because angular motion is accomplished through flexing of elastic flexural elements, rather than contact surface displacement, flexural pivots operate without friction and thus without a need for lubrication. Flexural pivots can therefore be a substitute for bearings in applications where friction and/or the need for lubrication are concerns.

Common problems with known commercial off-the-shelf (COTS) flexural pivots are repeatable performance and reliability, particularly where high performance and durability are required for the application. This can be due to the overall relatively high complexity and relatively a large number of components in known COTS flexural pivot designs, as well as the difficulty in manufacturing and/or fabricating such known COTS flexural pivots in a commercially viable manner. Thus, it is desirable to develop a flexural pivot design that provides high performance and reliability while being relatively simple and cost-effective to produce.

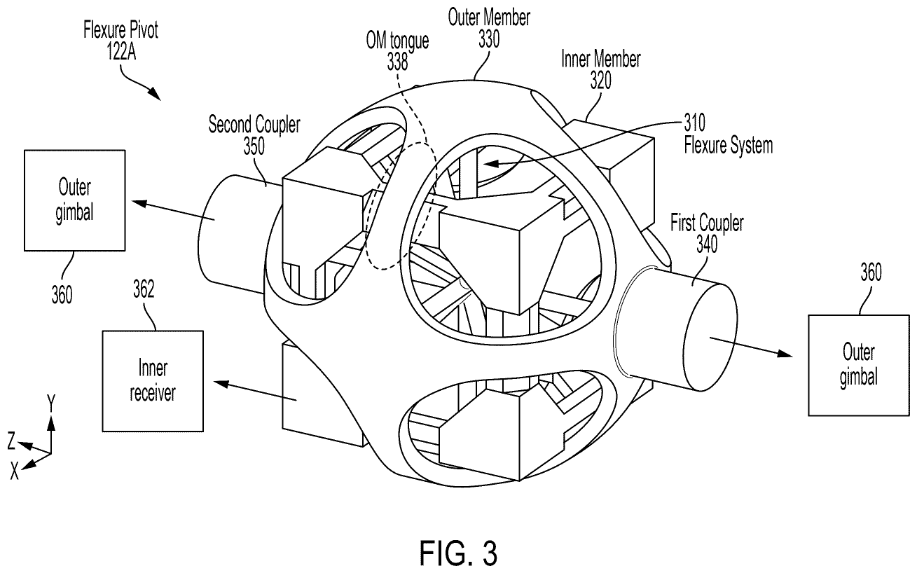

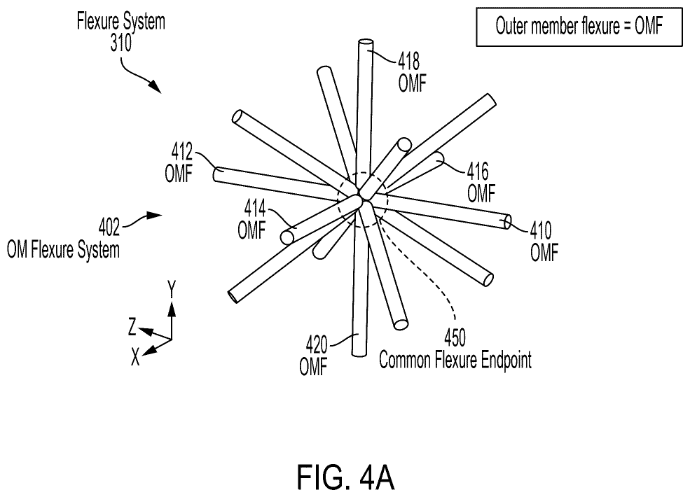

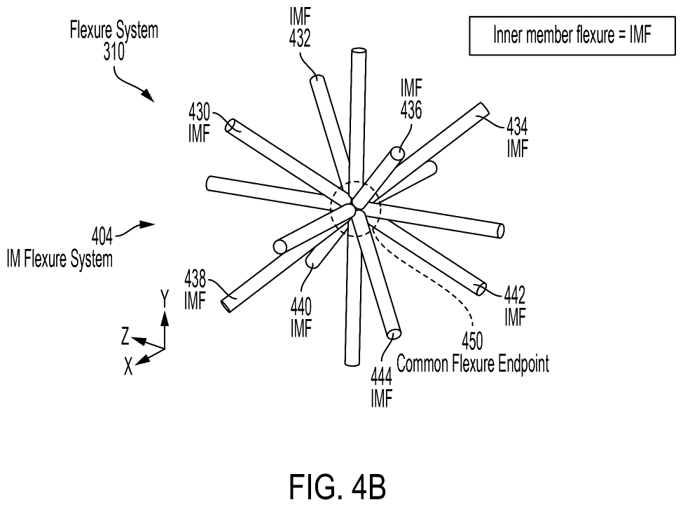

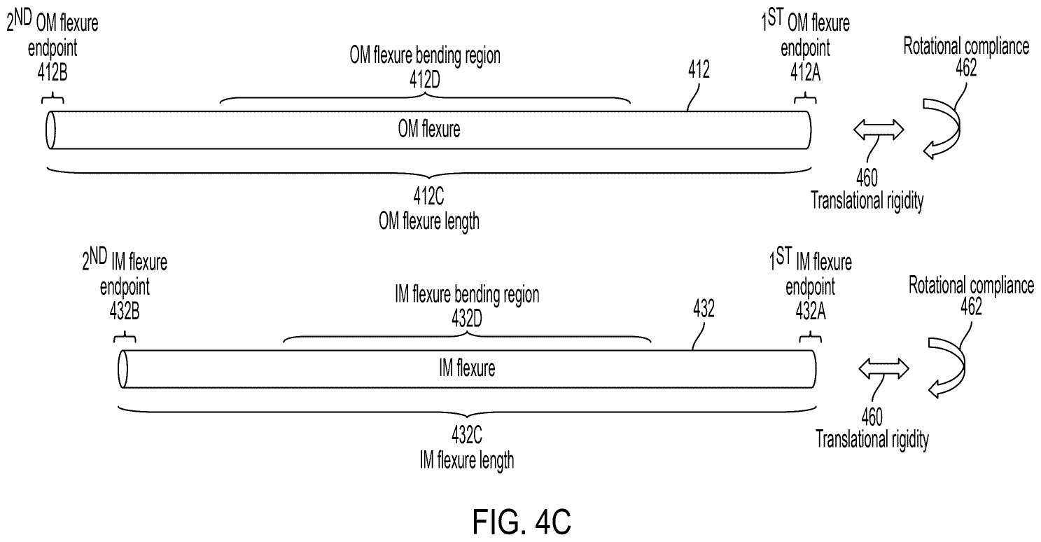

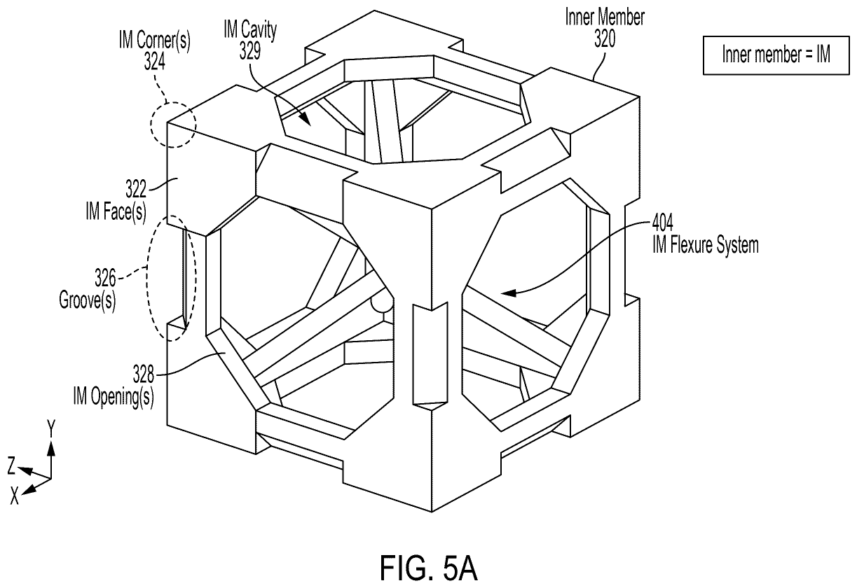

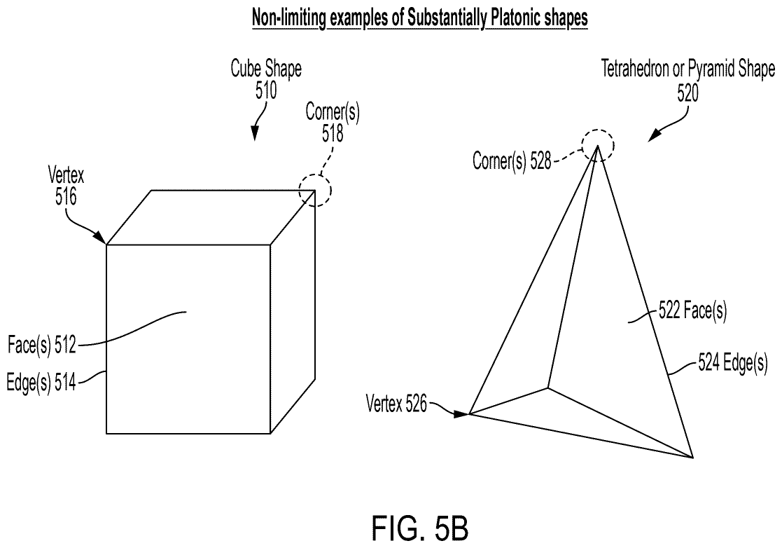

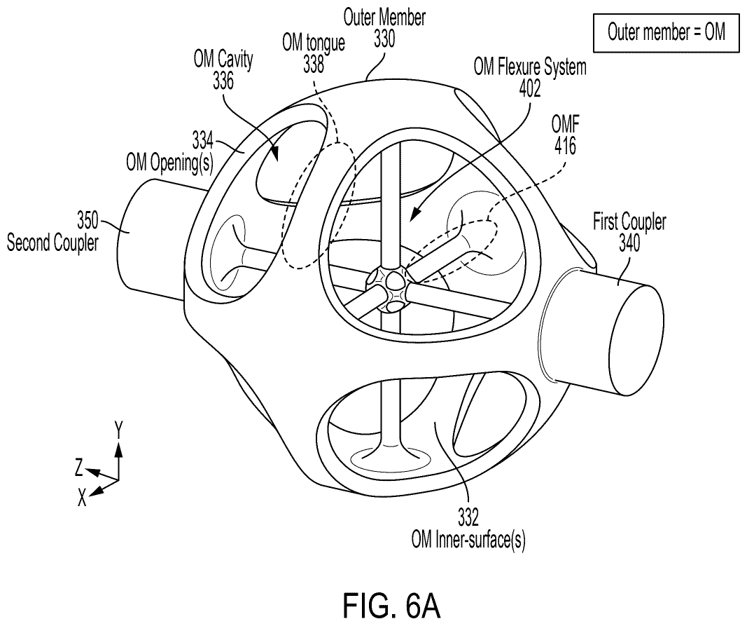

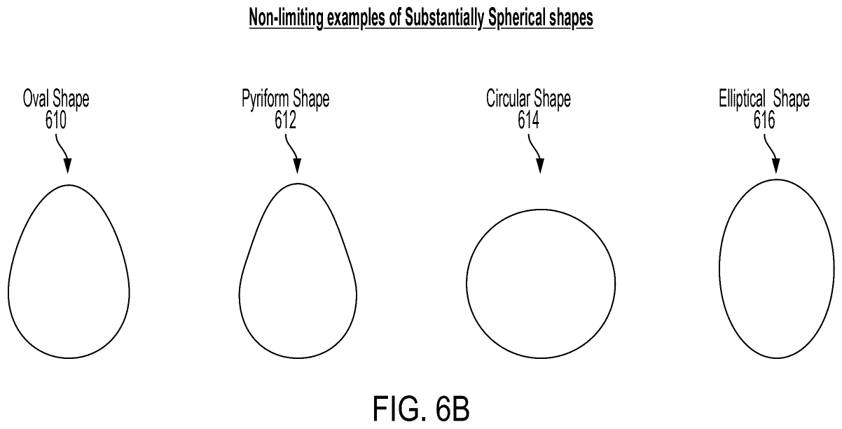

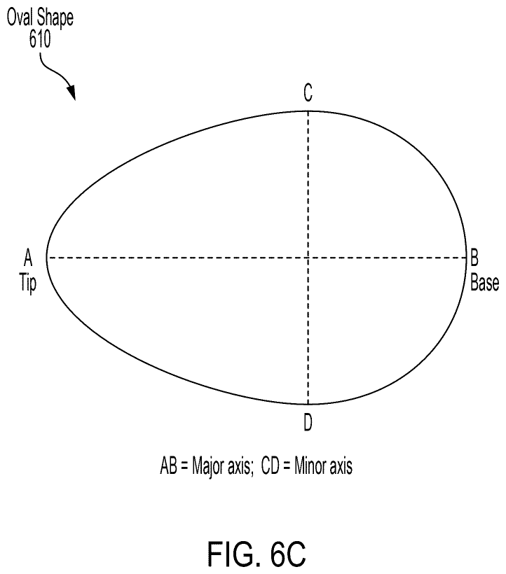

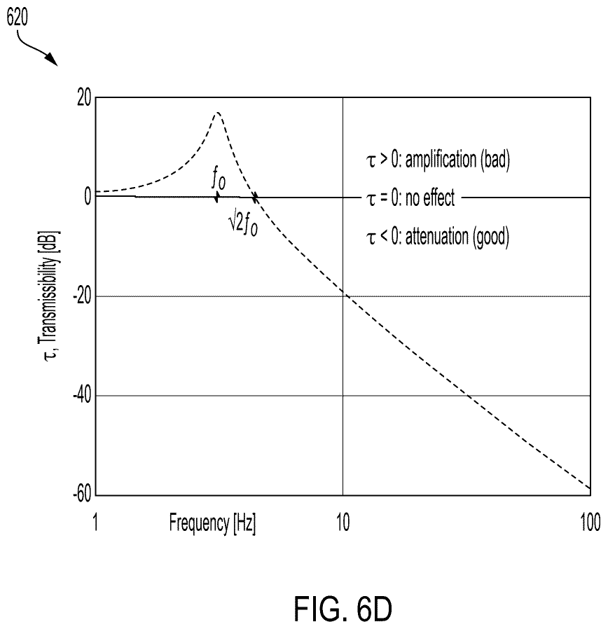

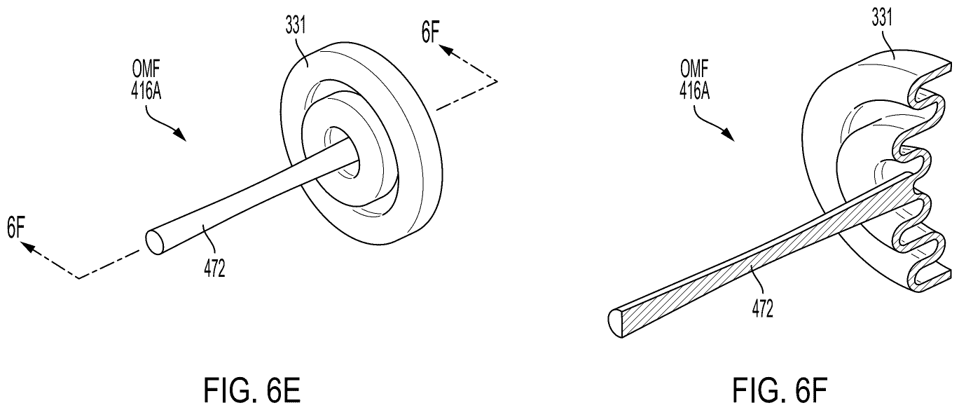

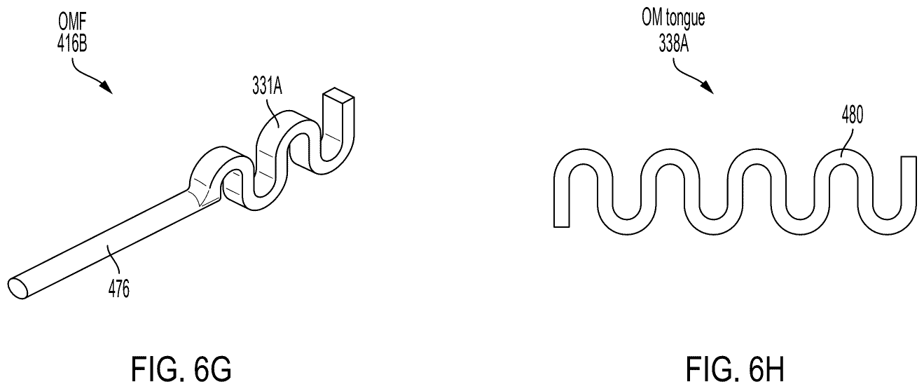

Accordingly, embodiments of the disclosure address the above-described shortcomings of known COTS flexural pivot designs by providing fabrication methods, use methods and structures for implementing the fine-compensation structure 122 as a novel flexural pivot 122A (shown in FIG. 3) operable to impart fine positional adjustments to the device 130 in order to stabilize the LOS 150 from the device 130 (e.g., a sensor) to the target 140. In some embodiments of the disclosure, the materials, functions, and design of the various components of the novel flexural pivot 122A lend themselves to convenient fabrication using additive manufacturing techniques. In some embodiments of the disclosure, the novel flexural pivot 122A includes three components, namely, a flexure system 310 (shown in isolation in FIG. 4A), an inner member 320 (shown in isolation in FIG. 5A) having an inner member (IM) shape, and an outer member 330 (shown in isolation in FIG. 6) having an outer member (OM) shape. The OM shape defines an OM cavity 336 (best shown in FIG. 6), the IM shape defines an IM cavity 329 (best shown in FIG. 5A), and the inner member 320 is at least partially positioned within the OM cavity 336 (best shown in FIG. 3).

In some embodiments of the disclosure, the IM shape is a substantially platonic shape (e.g., a square or a cube) having IM corners 324 (shown in FIG. 5A) and IM openings 328 (shown in FIG. 5A); and the OM shape is substantially spherical and includes OM openings. The individual elongated flexures of the IM flexure system 404 (shown in FIG. 4B) can be configured to connect to the inner member 320 (shown in isolation in FIG. 5A) at a corresponding one of the IM corners 324; and the individual flexures of the OM flexure system 402 (shown in FIG. 4A) can be configured to connect to the outer member 330 by passing through one of the IM openings 328 and connecting to an inner surface 332 of the outer member 330. In some embodiments of the disclosure, the inner member 320 is positioned within the OM cavity 336 such that the OM corners 328 fit at least partially within a corresponding one of the OM openings 328. In some embodiments of the disclosure, the inner member 320 is further positioned within the OM cavity 336 such that rotation of the inner member 320 and the outer member 330 with respect to one another is limited by the ability of each of the IM corners 324 to move within its corresponding OM opening 336.

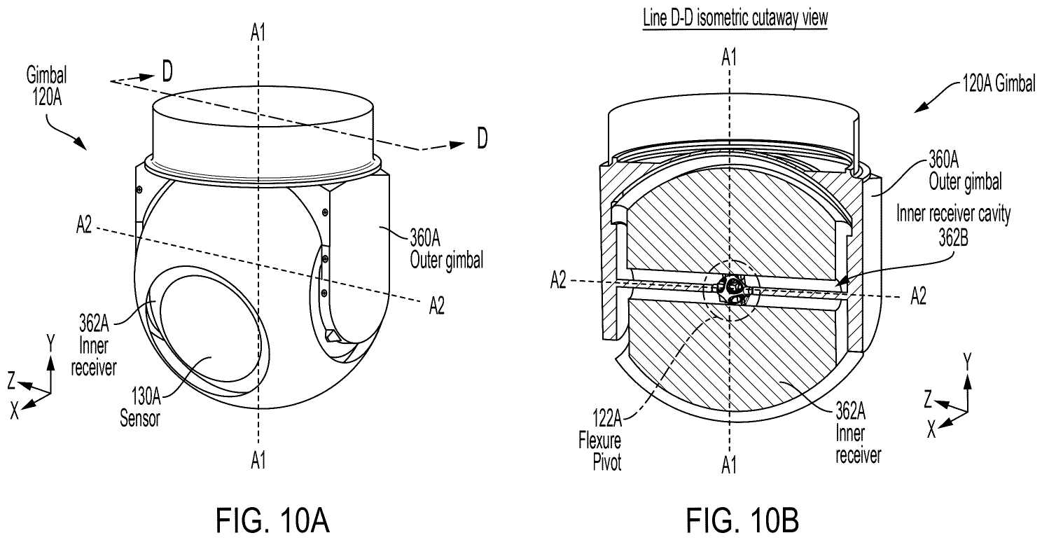

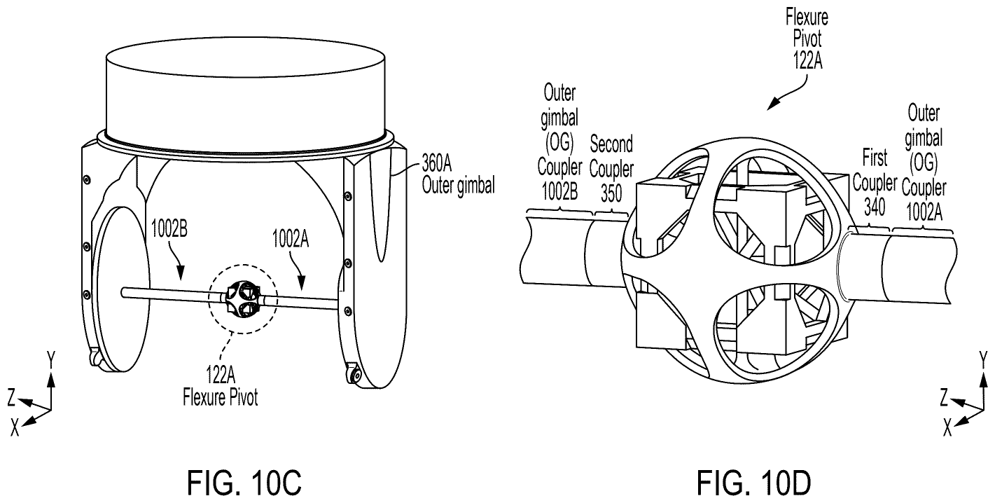

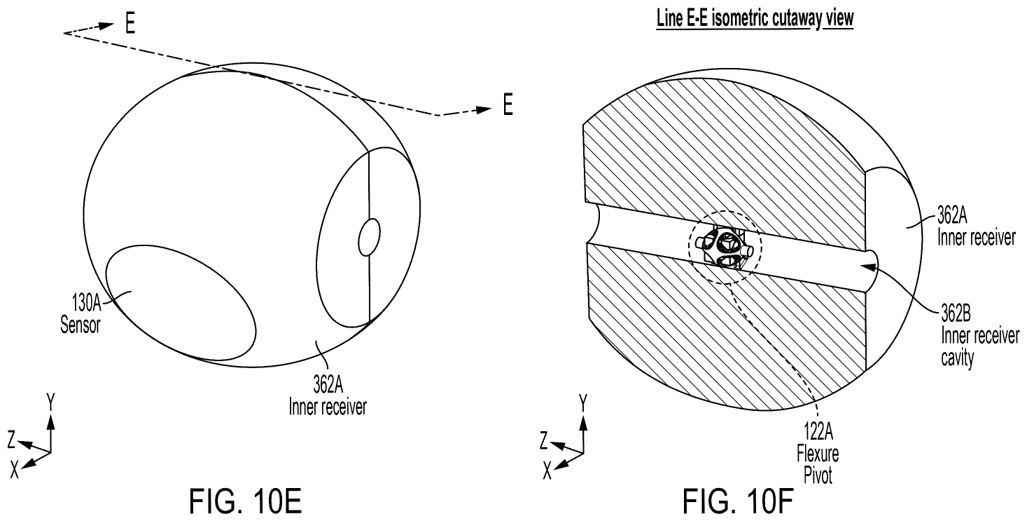

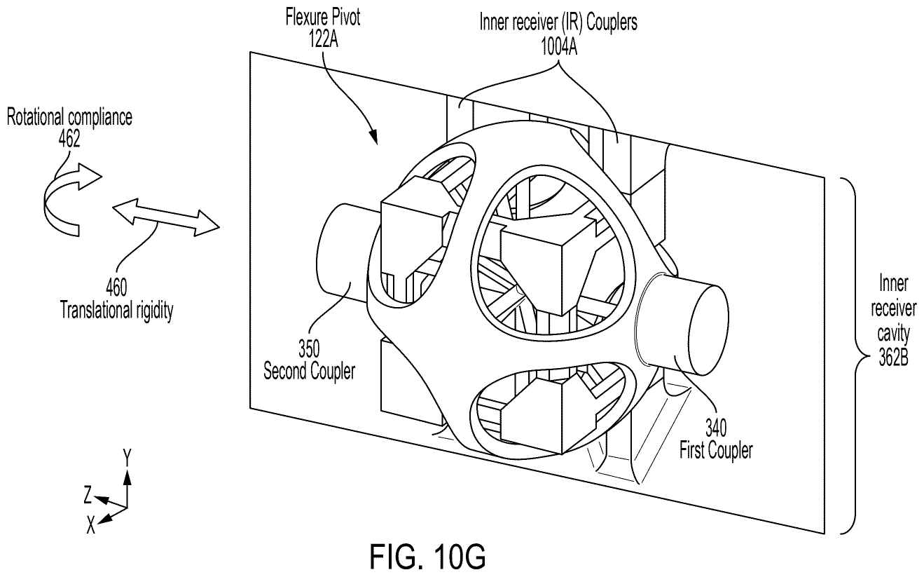

In some embodiments of the disclosure, the novel flexural pivot 122A (shown in FIG. 3) is coupled to the gimbal structure 120 that is coupled to the carrier 110 (e.g., a vehicle). In some embodiments of the disclosure, the gimbal structure 120 is a two-axis gimbal having a receiver element (e.g., inner receiver 362A shown in FIG. 10A) and a gimbal element (e.g., outer gimbal 360A). The receiver element is operable to house the device 130 (e.g., a sensor), couple to the outer gimbal element, and be rotated by the outer gimbal element around a first axis (e.g., axis A1-A1 shown in FIG. 10A) and/or a second axis (e.g., axis A2-A2 shown in FIG. 10A). For the first axis, the outer gimbal element is operable to rotate around the first axis, which also rotates the inner receiver element and the object/device being held by the inner receiver element around the first axis. For the second axis, the outer gimbal element is operable to rotate the inner receiver element around the second axis, which also rotates the inner receiver element and the device 130 being held by the inner receiver element around the first axis.

The novel flexural pivot 122A (shown in FIG. 3) is positioned within an inner receiver cavity (e.g., inner receiver cavity 362B shown in FIG. 10B) of the inner receiver element. The novel flexural pivot 122A is physically coupled to the inner receiver element by physically coupling the inner member 320 to an inner wall of the inner receiver cavity. The novel flexural pivot 122A is physically coupled to the outer gimbal element by an outer gimbal element coupling structure that includes a first outer gimbal coupler (1002B shown in FIGS. 10C and 10B); a second coupler (second coupler 350 shown in FIG. 10D) of the outer member 330; a first elongated flexure (e.g., OMF 412 shown in FIG. 4A) of the OM flexure system 402 (shown in FIG. 4A); the common flexure endpoint (e.g., common flexure endpoint 450 shown in FIG. 4A); a second elongated flexure (e.g., OMF 410 shown in FIG. 4A) of the OM flexure system; a first coupler (e.g., first coupler 340 shown in FIG. 10D) of the outer member 330; and a second outer gimbal coupler (e.g., outer gimbal coupler 1002A shown in FIG. 10D). The above-described coupling of the novel flexural pivot 122A to the inner receiver element and the outer gimbal element allows relatively small translational movement of the novel flexural pivot 122A within the inner receiver cavity but enables rotational movement of the inner member 320 with respect to the outer member 330 within the inner receiver element cavity. The rotational movement of the inner member 320 with respect to the outer member 330 within the inner receiver element cavity is initiated by applying a movement force through the above-described outer gimbal element coupling structure and the flexure systems to the inner member 320, which rotates the inner receiver element to which the inner member 320 is physically coupled. In accordance with embodiments of the disclosure, the rotational movement applied to the inner member 320 with respect to the outer member 330 is a fine compensation rotational movement. In some embodiments of the disclosure, the fine compensation movement is a rotation between about zero (0) degrees and about five (5) degrees.

Accordingly, the above-described novel flexure pivot 122A relies on bending of the individual elongated flexures to allow for rotation. The individual elongated flexures also act as translational stiffness because any translation load will be acted through the compression or tension through the axis of the above-described outer gimbal element coupling structure. Thus, the novel flexure pivot 122A can be used to execute very small rotation displacements of the inner receiver element to allow for fine-elevation (elevation=the Up and Down directions shown in FIG. 2) and cross-elevation rotational position control. The central location of the common endpoint (e.g., the common endpoint 450 shown in FIGS. 4A and 4B) allows for additional length (e.g., OM flexure length 412C and IM flexure length 432C shown in FIG. 4C) of the individual elongated flexures of the flexure system (e.g., flexure system 310 shown in FIGS. 4A and 4B), which allows for additional bending length and therefore reduction in bending moment at the ends of the flexures compared to known flexure designs. The connection of the IM flexures at the corner regions (e.g., IM corners 324 shown in FIG. 5A) of the inner member 320 allows less bending of individual elongated flexures in order to achieve the desired rotation of the inner member 320 and the inner receiver to which the inner member 320 is coupled.

The novel flexure pivot 122A can be formed from material types (e.g., steel, titanium, various polymers, and the like) that enable the novel flexural pivot to be fabricated using additive manufacturing techniques. Additive manufacturing will allow for the geometry of the novel flexure pivot to be achieved without having to meet the geometric constraints that currently exist with using machining and wire electrical discharge machining. Three-dimensional (3D) printing technology, also known as additive manufacturing, refers to a machine that fabricates a 3D physical object by using a printhead to successively form or deposit layers of material that will form a 3D physical object. The printhead operations are controlled by a computer that contains a 3D electronic model of the physical object. The 3D electronic model logically slices the physical object into several layers and provides instructions to the printhead for printing each layer. The instructions control the machine, and more specifically the printhead of the machine, to form/deposit each layer successively until the physical object is completed. The physical objects fabricated through 3D printing processes have a variety of shapes and geometries.

FIG. 3 depicts a simplified diagram illustrating a non-limiting example of how the fine-compensation structure 122 (shown in FIG. 1) can be implemented as the novel flexure pivot structure 122A in accordance with embodiments of the disclosure. The flexure pivot 122A includes a flexure system 310, an inner member 320, and an outer member 330, configured and arranged as shown. The flexure system 310 is positioned within the IM cavity 329 (best shown in FIG. 5A) of the inner member 320 and includes a plurality of individual flexures (e.g., outer member (OM) flexure 412 shown in FIG. 4C; and inner member (IM) flexure 430 shown in FIG. 4C) that are coupled to one another, the inner member 320 and the outer member 330. The inner member 320 is a substantially platonic-shaped structure (e.g., a cube) positioned within the OM cavity 336 (best shown in FIG. 6A) of the outer member 330. The outer member 330 includes a first coupler 340 and a second coupler 350, where the first coupler 340 and the second coupler 350 couple the outer member 330 to different regions of an outer gimbal 360, which can be a component of the gimbal 120 (shown in FIG. 1). The outer member 330 further includes OM tongue regions 338 that moveably within groove regions (e.g., IM grooves 326 shown in FIG. 5A) to facilitate the ability of the inner member 320 to move with respect to the outer member 330. Corner regions (e.g., IM corners 324 shown in FIG. 5A) of the inner member 320 couple the inner member 320 to an inner receiver 362, which can be a component of the gimbal 120. For ease of illustration and explanation, the flexure system 310, the inner member 320, and the outer member 330 are shown separately in FIGS. 4A, 4B, 4C, 5A, 5B, and 6A and described in greater detail subsequently herein.

FIGS. 4A, 4B, and 4C depict additional details of the flexure system 310. The flexure system 310 includes an OM flexure system 402 and an IM flexure system 404. For ease of illustration, the individual flexures of the OM flexure system 402 are marked with reference numbers in FIG. 4A; and the individual flexures of the IM flexure system 404 are marked with reference numbers in FIG. 4B. As shown in FIG. 4A, the individual flexures of the OM flexure system 402 includes OM flexure (OMF) 410, OMF 412, OMF 414, OMF 416, OMF 418, and OMF 420, configured and arranged as shown. As shown in FIG. 4B, the individual flexures of the IM flexure system 404 includes IM flexure (IMF) 430, IMF 432, IMF 434, IMF 436, IMF 438, IMF 440, IMF 442, and IMF 444, configured and arranged as shown. In FIG. 4A, the angles between the individual flexures of the OM flexure system 402 can be all different, all the same, and/or a combination of some angles being the same and some angles being different. In FIG. 4B, the angles between the individual flexures of the IM flexure system 404 can be all different, all the same, and/or a combination of some angles being the same and some angles being different. In aspects of the disclosure, a steady-state position of the inner member 320 (shown in FIG. 3) with respect to the outer member 330 (shown in FIG. 3) includes an initial position of the inner member 320 with respect to the outer member 330. This initial position of the inner member 320 with respect to the outer member 330 can define an initial level of stress or strain applied through the inner member 320 and the outer member 330 to the flexures system 310. In some embodiments of the disclosure, under this initial level of stress or strain, substantially no bending occurs in the individual flexures of the flexure system 310.

In FIG. 4C, an example individual flexure of the OM flexure system 402 is shown as OM flexure 412; and an example individual flexure of the IM flexure system 404 is shown as IM flexure 432. All of the OM flexures of the OM flexure system 402 have substantially the same features as the OM flexure 412 shown in FIG. 4C; and all of the IM flexures of the IM flexure system 404 have substantially the same features as the IM flexure 432 shown in FIG. 4C. The OM flexure 412 includes a first OM flexure endpoint 412A, a second OM flexure endpoint 412B, an OM flexure length 412C, and an OM flexure bending region 412D, configured and arranged as shown. Similarly, the IM flexure 432 includes a first IM flexure endpoint 432A, a second IM flexure endpoint 432B, an IM flexure length 432C, and an IM flexure bending region 432D, configured and arranged as shown. Through bending, rotational compliance 462 of the OM flexure 412 is allowed in the OM flexure bending region 412D. However, the OM flexure 412 provides some translational rigidity 460. Similarly, through bending, rotational compliance 462 of the IM flexure 432 is allowed in the IM flexure bending region 412D. However, the IM flexure 432 provides some translational rigidity 460.

As best shown in FIGS. 4A and 4B, the elongated individual flexures of the IM flexure system 404 and the OM flexure system 402 have two termination end points that terminate in two of three locations. A location where all of the individual flexures of the IM flexure system 404 and the OM flexure system 402 terminate is a common flexure endpoint 450; a location where all of the individual flexures of the IM flexure system 404 terminate is the inner member 320 (e.g., the IM corners 324 shown in FIG. 5A); and a location where all of the individual flexures of the OM flexure system 402 terminate is the outer member 330 (e.g., on the OM inner-surfaces 332 shown in FIG. 6). The inner member 320 and the outer member 330 are operable to move or rotate with respect to one another, and this movement/rotation is enabled by application of movement forces to the inner member 320 and/or the outer member 330, along with an ability of the individual flexures of the IM flexure system 404 and the OM flexure system 404 to bend. As shown in FIG. 4C, the length of each individual flexure (e.g., OM flexure length 412C and IM flexure length 432C) is sufficiently long to ensure that the primary bending of the individual flexure occurs in a flexure bending region (e.g., OM flexure bending region 412D and IM flexure bending region 432D) that is away from either of the two flexure endpoints (e.g., first OM flexure endpoint 412A and second OM flexure endpoint 412B; or first IM flexure endpoint 432A and second IM flexure endpoint 432B).

In some embodiments of the disclosure, various components of the flexure pivot 122A can be configured (e.g., through materials and/or shapes of components of the flexure pivot 122A) to provide translational compliance (e.g., relative compliance between the outer member 330 and the inner member 320) that isolates vibration imparted to the flexure pivot 122A such that the flexure pivot 122A does not transfer such vibrations to the inner receiver 362 and/or the outer gimbal 360. FIG. 6D depicts a transmissibility response plot 620 illustrating vibration isolation functionality of embodiments of the disclosure. The transmissibility plot 620 illustrates how compliance of the outer member 330 allows for a receiver vibration frequency that peaks at f₀ and rolls off at high frequencies (Hz).

FIGS. 6E and 6F depict a non-limiting example of how one or more of the individual flexures of the OM flexure system 402 can be coupled to the outer member 330 in accordance with aspects of the disclosure to provide end flexibility to allow for translational compliance that isolates vibrations in the flexure pivot 122A from the inner receiver 362 and the outer gimbal 360. As an example, the OMF 416 (shown in FIG. 4A) can be implemented as OMF 416A, which includes a flexure section 472 and a coupler 331. One end of the flexure 472 is mechanically coupled to the coupler 331 and the opposite end of the flexure 472 is mechanically coupled to the common flexure endpoint 450 (shown in FIG. 4A). The coupler 331 is also mechanically coupled to a portion of the OM inner-surfaces 332 (shown in FIG. 6A). The coupler 331 has circular regions (viewed from the top-down view), along with a serpentine cross-sectional regions (viewed from the cross-sectional view shown in FIG. 6F), both of which provide additional translational compliance for the outer member 330 and additional surface areas of the coupler 331 for absorbing vibrations.

FIG. 6G depicts another non-limiting example of how one or more of the individual flexures of the OM flexure system 402 can be coupled to the outer member 330 in accordance with aspects of the disclosure to provide end flexibility to allow for translational compliance that isolates vibrations in the flexure pivot 122A from the inner receiver 362 and the outer gimbal 360. As an example, the OMF 416 (shown in FIG. 4A) can be implemented as OMF 416B, which includes a flexure section 476 and a coupler 331A. One end of the flexure 476 is mechanically coupled to the coupler 331A and the opposite end of the flexure 476 is mechanically coupled to the common flexure endpoint 450 (shown in FIG. 4A). The coupler 331A is also mechanically coupled to a portion of the OM inner-surfaces 332 (shown in FIG. 6A). The coupler 331 has a serpentine region, which provide additional translational compliance for the outer member 330 and additional surface areas of the coupler 331 for absorbing vibrations.

FIG. 6H depicts another non-limiting example of how one or more of portions of the outer member 330 in accordance with aspects of the disclosure can be configured to provide end flexibility to allow for translational compliance that isolates vibrations in the flexure pivot 122A from the inner receiver 362 and the outer gimbal 360. As an example, the OM tongue 338 (shown in FIG. 6A) can be implemented as OM tongue 338A, which a serpentine contour 480, which provides additional translational compliance for the outer member 330 and additional surface areas of the outer member 330 for absorbing vibrations.

FIG. 5A depicts a simplified diagram illustrating an isolated view of the inner member 320 and a partial view of the IM flexure system 404 positioned within the IM cavity 329. As shown, the inner member 320 has a substantially square or cube shape that defines the IM cavity 329, IM openings 328, IM corners 324, IM Faces 322, and IM grooves 326, configured and arranged as shown. The second flexure endpoints (e.g., second IM flexure endpoint 412B shown in FIG. 4C) of the IM flexure system 404 are coupled to the inner member 320 at the IM corners 324. The IM openings 328 extend through the IM faces 322 and provide a pathway for the second flexure endpoints (e.g., second OM flexure endpoints 412B shown in FIG. 4C) of the OM flexure system 402 (shown in FIG. 4A) to couple to OM inner-surfaces 332 (shown in FIG. 6) of the outer member 330 (shown in FIG. 6). The IM grooves 326 provides a pathway for OM tongue regions 338 (shown in FIGS. 3 and/or 6A) of the outer member 330 to move through when the inner member 320 and the outer member 330 move with respect to one another.

FIG. 5B depicts simplified diagrams illustrating non-limiting examples of substantially platonic shapes that can be used to implement the inner member 320 in accordance with embodiments of the disclosure. Non-limiting examples of substantially platonic shapes include geometric shapes having faces that are all identical, regular polygons meeting at the same three-dimensional angles. Also known as the regular polyhedra, these geometric shapes include but are not limited to the tetrahedron (or pyramid), the cube, the octahedron, the dodecahedron, the icosahedron, and the like. FIG. 5B illustrates examples of substantially platonic shapes, which are shown as a cube shape 510 and a tetrahedron or pyramid shape 520. In general, a substantially platonic shape such as the cube shape 510 and/or the pyramid shape 520 will include a plurality of faces (e.g., faces 512, 522) that are connected to one another in a manner that forms a plurality of edges (e.g., edges 514, 524), a plurality of vertices (e.g., vertices 516, 526), and a plurality of corners (e.g., corners 518, 528). The vertex is a point where two lines or rays meet forming an angle at that point; and a corner is a point where two or more lines meet. Because the cube shape 510 and the pyramid shape 520 are both a three-dimensional (3D) objects, the corners 518, 528 will be any point where three lines meet. The cube shape 510 has eight such points where three lines meet, so the cube shape 510 has eight corners 518. The pyramid shape 520 has four such points where three lines meet, so the pyramid shape 520 has four corners 528.

FIG. 6A depicts a simplified diagram illustrating an isolated view of the outer member 330 and a partial view of the OM flexure system 402 positioned within the OM cavity 336. As shown, the outer member 330 has a substantially spherical shape that defines the OM cavity 336, OM openings 334, OM inner surfaces 332, OM tongue regions 338, the first coupler 340, and the second coupler 350, configured and arranged as shown. The second flexure endpoints (e.g., second OM flexure endpoint 432B shown in FIG. 4C) of the OM flexure system 402 are coupled to the outer member 330 at various locations on the OM inner-surfaces 332. The OM openings 334 extend through the OM inner faces 332 and provide spaces within which the IM corners 324 (shown in FIG. 5A) can move when the inner member 320 moves with respect to the outer member 330 while performing fine-compensation operations. The IM grooves 326 (shown in FIG. 5A) provides a pathway for OM tongue regions 338 of the outer member 330 to move through when the inner member 320 and the outer member 330 move with respect to one another. The outer member 330 includes a first coupler 340 and a second coupler 350, where the first coupler 340 and the second coupler 350 couple the outer member 330 to different regions of an outer gimbal 360, which can be a component of the gimbal 120 (shown in FIG. 1).

FIG. 6B depicts simplified diagrams illustrating non-limiting examples of substantially spherical shapes that can be used to implement the outer member 330 in accordance with embodiments of the disclosure. Non-limiting examples of substantially spherical shapes include, but are not limited to, the oval shape 610, the pyriform shape 612, the circular shape 614 and the elliptical shape 616 shown in FIG. 6B. As shown in FIG. 6C, and using the oval shape 610 as an example, the substantially spherical shapes 610, 612, 614, 616 are defined by a major axis AB and a minor axis CD having substantially curved surfaces; and the substantially spherical shape is defined by the sizes of the major axis and the minor axis, as well as the relative location of the major axis with respect to the minor axis.

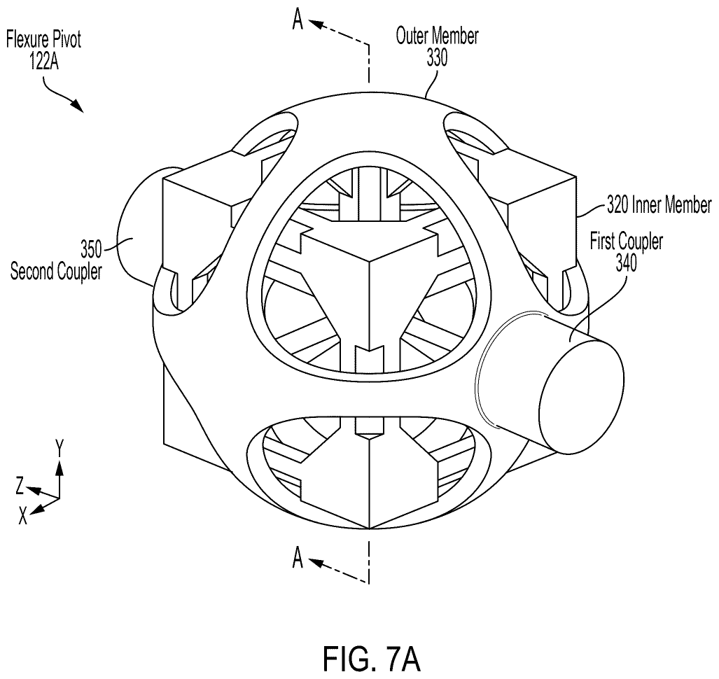

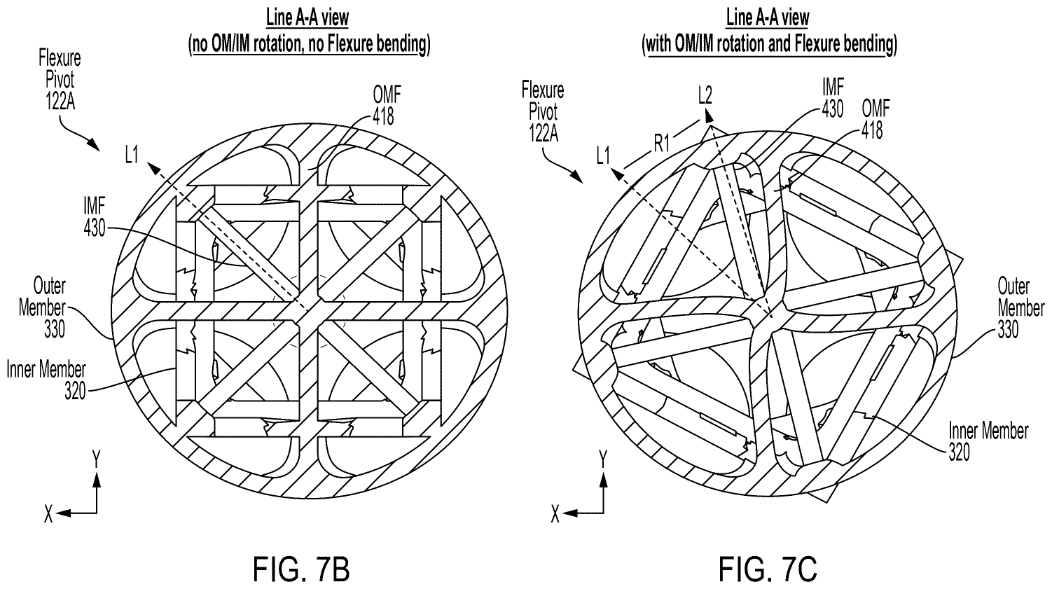

FIGS. 7A, 7B, and 7C depict isometric (FIG. 7A) and cross-sectional views (FIGS. 7B and 7C) of the flexure pivot 122A that illustrate a steady-state position of the inner member 320 with respect to the outer member 330 (FIG. 7B); a rotational movement of the inner member 320 with respect to the outer member 330 (FIG. 7B); and the flexure bending associated with the rotational movement of the inner member 320 with respect to the outer member 330 (FIG. 7C). In aspects of the disclosure, the steady-state position of the inner member 320 with respect to the outer member 330 includes an initial position of the inner member 320 with respect to the outer member 330. This initial position of the inner member 320 with respect to the outer member 330 can define an initial level of stress or strain applied through the inner member 320 and the outer member 330 to the flexures system 310 (shown in FIGS. 4A and 4B). In some embodiments of the disclosure, under this initial level of stress or strain, substantially no bending occurs in the individual flexures of the flexure system 310. The isometric view of the flexure pivot 122A shown in FIG. 7A is substantially the same as the isometric view of the flexure pivot 122A shown in FIG. 3 except the line A-A for the cross-sectional views shown in FIGS. 7B and 7C has been added to the flexure pivot 122A shown in FIG. 7A. In the line A-A view shown in FIG. 7B, the inner member 320 is in a steady state with respect to the outer member 330, which, in the embodiment of the disclosure shown in FIG. 7B, is reflected by the “steady-state” directional arrow L1. The steady-state directional arrow L1 shows the IM corners 324 of the inner member 320 in their steady-state position within their corresponding OM opening 328 of the outer member 330. This steady-state position is also reflected by the relative positions of the inner member 320 and the outer member 330 shown in FIG. 3. In the steady-state position, no movement force is applied to the inner member 320 and/or the outer member 330; and no bending occurs in the flexure members (e.g., IMF 430 and OMF 418 shown in FIG. 7B) of the IM flexure system 404 (shown in FIG. 4B) and the OM flexure system 402 (shown in FIG. 4A).

In FIG. 7C, movement force has been applied to the inner member 320 and/or the outer member 330, which results in the inner member 320 and the outer member 330 moving with respect to one another such that the IM corners 324 occupy a post-movement position within the OM openings 328. This “post-movement” position is represented by the post-movement directional arrow L2 shown in FIG. 7C, and the linear or rotational distance of the post-movement location is represented by the linear or angular distance R1 shown in FIG. 7C. As shown in FIG. 7C, in addition to the movement force applied to the inner member 320 and the outer member 330, the post-movement location L2 is achieved or enabled by bending in the flexures of the OM flexure system 402 and the flexures of the IM flexure system 404, examples of which are OMF 418 and IMF 430 shown in FIG. 7C. Although one post-movement position L2 is shown in FIG. 7C, it is understood that the movement force and flexure bending can allow the IM corners 324 to occupy any location within its corresponding OM opening 328.

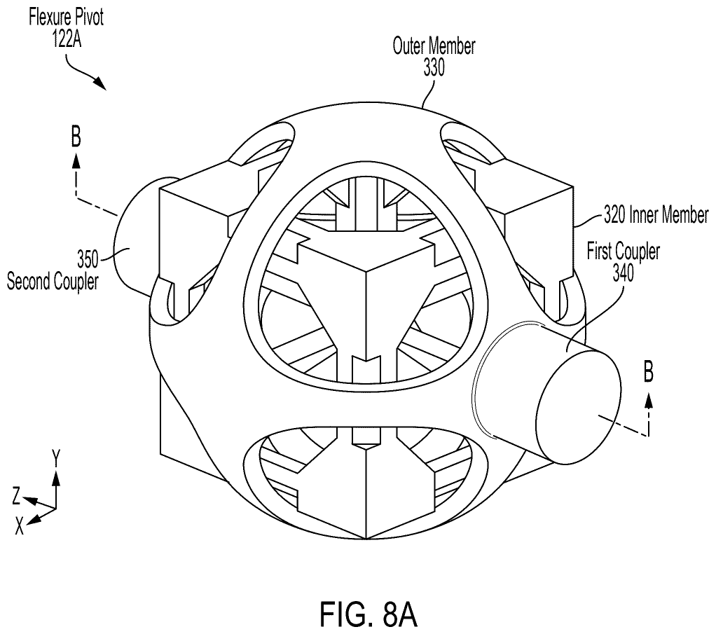

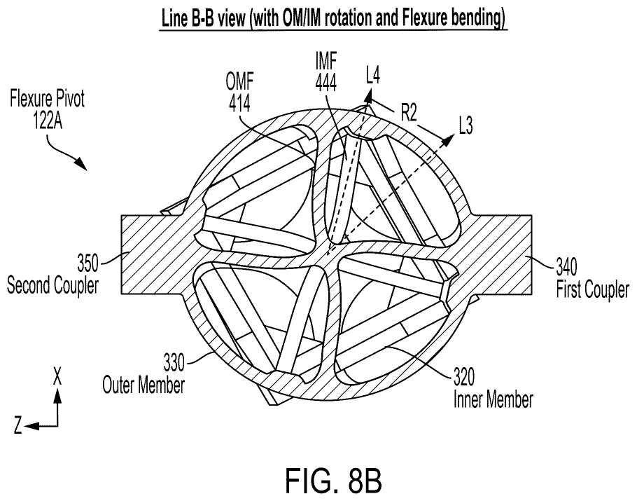

FIGS. 8A and 8B depict isometric (FIG. 8A) and cross-sectional views (FIG. 8B) of the flexure pivot 122A that illustrates a rotational movement (FIG. 8B) of the inner member 320 with respect to the outer member; and the flexure bending (FIG. 8B) associated with the rotational movement of the inner member 320 with respect to the outer member 330. The isometric view of the flexure pivot 122A shown in FIG. 8A is substantially the same as the isometric view of the flexure pivot 122A shown in FIG. 3 except the line B-B for the cross-sectional view shown in FIG. 8B has been added to the flexure pivot 122A shown in FIG. 8A. For convenience, the steady-state position of the inner member 320 with respect to the outer member 330 is represented by the steady-state directional arrow L3 shown in FIG. 8B and is not shown in a separate line B-B cross-sectional view. Similar to the steady-state directional arrow L1 shown in FIG. 7B, the steady-state directional arrow L3 represents the IM corners 324 of the inner member 320 in their steady-state position within their corresponding OM opening 328 of the outer member 330. This steady-state position is also reflected by the relative positions of the inner member 320 and the outer member 330 shown in FIG. 3. In the steady-state position represented by the steady-state directional arrow L3, no movement force is applied to the inner member 320 and/or the outer member 330; and no bending occurs in the flexure members (e.g., IMF 444 shown in FIG. 4B; and OMF 414 shown in FIG. 4A) of the IM flexure system 404 (shown in FIG. 4B) and the OM flexure system 402 (shown in FIG. 4A).

In FIG. 8B, movement force has been applied to the inner member 320 and/or the outer member 330, which results in the inner member 320 and the outer member 330 moving with respect to one another such that the IM corners 324 occupy a post-movement position within the OM openings 328. This “post-movement” position is represented by the post-movement directional arrow L4 shown in FIG. 8B, and the linear or rotational distance of the post-movement location is represented by the linear or angular distance R2 shown in FIG. 8B. As shown in FIG. 8B, in addition to the movement force applied to the inner member 320 and the outer member 330, the post-movement location L4 is achieved or enabled by bending in the flexures of the OM flexure system 402 (shown in FIG. 4A) and the flexures of the IM flexure system 404 (shown in FIG. 4B), examples of which are OMF 414 and IMF 444 shown in FIG. 8B. Although one post-movement position L4 is shown in FIG. 8B, it is understood that the movement force and flexure bending can allow the IM corners 324 to occupy any location within its corresponding OM opening 328.

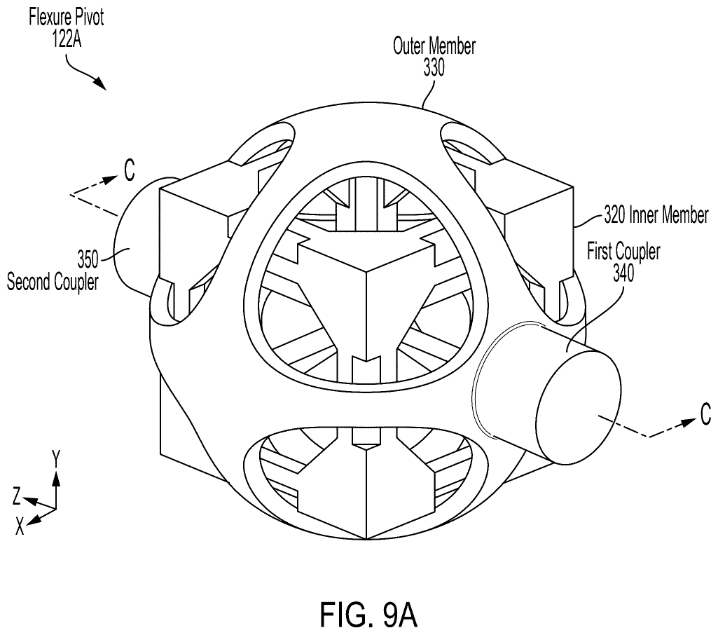

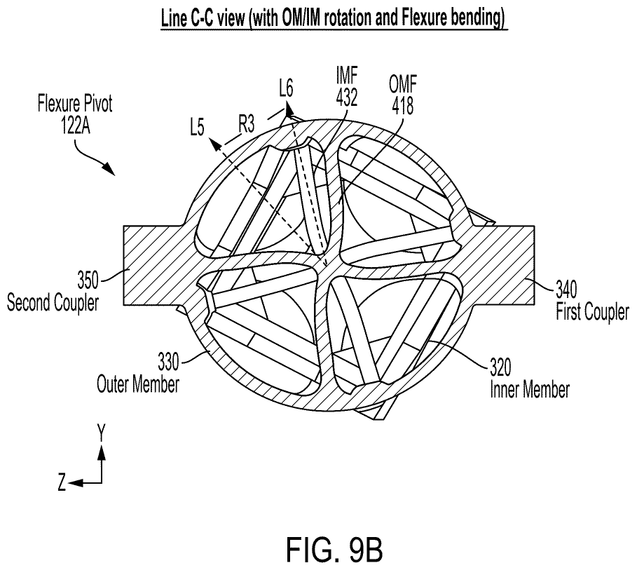

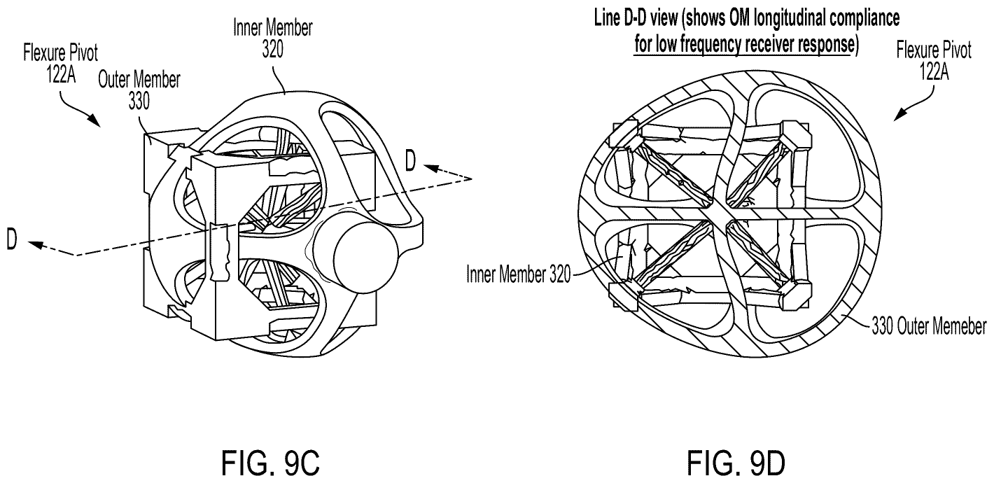

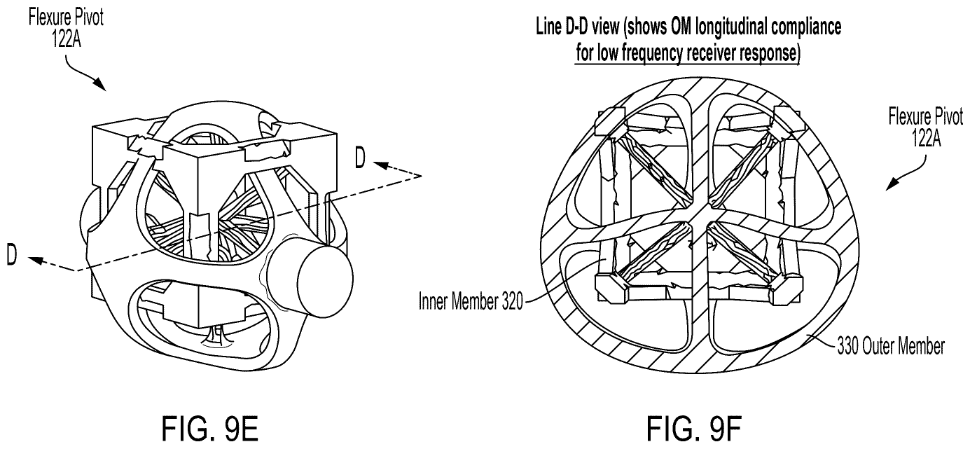

FIGS. 9A and 9B depict isometric (FIG. 9A) and cross-sectional views (FIG. 9B) of the flexure pivot 122A that illustrates a rotational movement (FIG. 9B) of the inner member 320 with respect to the outer member; and the flexure bending (FIG. 9B) associated with the rotational movement of the inner member 320 with respect to the outer member 330. The isometric view of the flexure pivot 122A shown in FIG. 9A is substantially the same as the isometric view of the flexure pivot 122A shown in FIG. 3 except the line C-C for the cross-sectional view shown in FIG. 9B has been added to the flexure pivot 122A shown in FIG. 9A. For convenience, the steady-state position of the inner member 320 with respect to the outer member 330 is represented by the steady-state directional arrow L5 shown in FIG. 9B and is not shown in a separate line C-C cross-sectional view. Similar to the steady-state directional arrow L1 shown in FIG. 7B, the steady-state directional arrow L5 represents the IM corners 324 of the inner member 320 in their steady-state position within their corresponding OM opening 328 of the outer member 330. This steady-state position is also reflected by the relative positions of the inner member 320 and the outer member 330 shown in FIG. 3. In the steady-state position represented by the steady-state directional arrow L5, no movement force is applied to the inner member 320 and/or the outer member 330; and no bending occurs in the flexure members (e.g., IMF 432 shown in FIG. 4B; and OMF 418 shown in FIG. 4A) of the IM flexure system 404 (shown in FIG. 4B) and the OM flexure system 402 (shown in FIG. 4A).

In FIG. 9B, movement force has been applied to the inner member 320 and/or the outer member 330, which results in the inner member 320 and the outer member 330 moving with respect to one another such that the IM corners 324 occupy a post-movement position within the OM openings 328. This “post-movement” position is represented by the post-movement directional arrow L6 shown in FIG. 9B, and the linear or rotational distance of the post-movement location is represented by the linear or angular distance R3 shown in FIG. 9B. As shown in FIG. 9B, in addition to the movement force applied to the inner member 320 and the outer member 330, the post-movement location L6 is achieved or enabled by bending in the flexures of the OM flexure system 402 (shown in FIG. 4A) and the flexures of the IM flexure system 404 (shown in FIG. 4B), examples of which are OMF 418 and IMF 432 shown in FIG. 9B. Although one post-movement position L6 is shown in FIG. 9B, it is understood that the movement force and flexure bending can allow the IM corners 324 to occupy any location within its corresponding OM opening 328.

FIG. 9C depicts an isometric view of the flexure pivot 122A. The isometric view of the flexure pivot 122A shown in FIG. 9C is substantially the same as the isometric view of the flexure pivot 122A shown in FIG. 3 except the line D-D for the cross-sectional views shown in FIG. 9D has been added to the flexural pivot 122A shown in FIG. 9C. As shown in FIG. 9C, and as best shown in the Line D-D view shown in FIG. 9D, the inner member 320 translates longitudinally relative to the outer member 330 by a relatively small amount due to compliance of the outer member 330. This relatively small amount of longitudinal translation can be enhanced by the OMF 416A (shown in FIGS. 6E and 6F), the OMF 416B (shown in FIG. 6G), and the OM tongue 338A (shown in FIG. 6H).

FIG. 9E depicts an isometric view of the flexure pivot 122A. The isometric view of the flexure pivot 122A shown in FIG. 9E is substantially the same as the isometric view of the flexure pivot 122A shown in FIG. 3 except the line D-D for the cross-sectional views shown in FIG. 9F has been added to the flexural pivot 122A shown in FIG. 9D. As shown in FIG. 9D, and as best shown in the Line D-D view shown in FIG. 9F, the inner member 320 translates vertically relative to the outer member 330 by a relatively small amount due to compliance of the outer member 330. This relatively small amount of vertical translation can be enhanced by the OMF 416A (shown in FIGS. 6E and 6F), the OMF 416B (shown in FIG. 6G), and the OM tongue 338A (shown in FIG. 6H).

FIG. 10A depicts a simplified diagram illustrating an isometric view of a non-limiting example of how the gimbal structure 120 of FIG. 1 can be implemented as a gimbal structure 120A in accordance with embodiments of the disclosure. The gimbal structure 120A is a 2-axes gimbal operable to rotate around an A1-A1 axis and an A2-A2 axis. In the embodiments depicted in FIGS. 10A-10F, the gimbal structure 120A is implemented as a multi-spectral targeting system (MTS) that combines electro-optical/infrared (EO/IR), laser designation, and laser illumination capabilities in a single sensor package. In embodiments where the gimbal structure 120 is an MTS, the carrier 110 (shown in FIG. 1) can be implemented as a variety of different types of unmanned aerial vehicles (UAVs). The gimbal structure 120A includes an outer gimbal 360A, an inner receiver 362A, and a sensor 130A, configured and arranged as shown. The sensor 130A is a non-limiting example of how the device 130 (shown in FIG. 1) can be implemented. The outer gimbal 360A rotates around the A1-A1 axis; and the inner receiver 362A physically couples to the outer gimbal 360A such that the inner receiver 362A can also be rotated around the A1-A1 axis with the outer gimbal 360A. The inner receiver 362A also rotatably couples to the outer gimbal 360A such that the inner receiver 362A can also be rotated around the A2-A2 axis.

FIG. 10B depicts a simplified diagram illustrating an isometric cutaway view of the gimbal structure 120A taken along line D-D shown in FIG. 10A. The cutaway view of the gimbal structure 120A illustrates the novel flexure pivot 122A, which is positioned within an elongated inner receiver cavity 362B of the inner receiver 362A; physically coupled to the inner receiver 362A; and rotatably coupled to the outer gimbal 360A. The couplings from the novel flexure pivot 122A to the inner receiver 362A; and the couplings from the novel flexure pivot 122B to the outer gimbal 360A, are shown in greater detail in FIGS. 10C, 10D, and 10G and described subsequently herein. The controller 112 and the motor & sensor system 114 of the carrier 110 (or UAV) (shown in FIG. 1) are configured and arranged to control course compensation movements of the gimbal 120A and the associated sensor 130A, as well as the fine compensation movements transferred to the gimbal 120A and the associated sensor 130A through the novel flexure pivot 122A.

FIG. 10C depicts a simplified diagram that illustrates isolated views of the outer gimbal 360A, the novel flexure pivot 122A, and a general illustration of the couplings 1002A, 1002B between the novel flexure 122A and the outer gimbal 360A. FIG. 10D depicts a simplified diagram that further isolates the novel flexure pivot 122A, along with the additional details of the couplings between the novel flexure pivot 122A and the outer gimbal 360A. As shown in FIG. 10D, the couplings between the novel flexure pivot 122A and the outer gimbal 360A include the first coupler 340 and the outer gimbal (OG) coupler 1002A at one end of the novel flexure pivot 122A. Additionally, FIG. 10D depicts that the couplings between the novel flexure pivot 122A and the outer gimbal 360A further include the second coupler 350 and the OG coupler 1002B at an opposite end of the novel flexure pivot 122A.

FIG. 10E depicts a simplified diagram illustrates an isolated view of the inner receiver 362A and the sensor 130A of the gimbal structure 120A shown in FIGS. 10A and 10B. FIG. 10F depicts a simplified diagram illustrating an isometric cutaway view of the inner receiver 362A taken along line E-E shown in FIG. 10E. The cutaway view of the inner receiver 362A illustrates the novel flexure pivot 122A, which is positioned within the elongated inner receiver cavity 362B of the inner receiver 362A, and which is physically coupled to the inner receiver 362A. FIG. 10G depicts an isolated and expanded view of the novel flexure pivot 122A within the inner receiver cavity 362B. As shown in FIG. 10G, inner receiver (IR) couplers 1004A are configured and arranged to couple to four of the IM corners 324 (best shown in FIG. 5A). Through bending of the individual flexures of the flexure system 310 (best shown in FIG. 3), rotational compliance 462 of the inner member 320 with respect to the outer member 330 is allowed. However, translational rigidity 460 is provided by an outer gimbal element coupling structure that includes a first outer gimbal coupler (1002B shown in FIGS. 10C and 10B); a second coupler (second coupler 350 shown in FIG. 10D) of the outer member 330; a first elongated flexure (e.g., OMF 412 shown in FIG. 4A) of the OM flexure system 402 (shown in FIG. 4A); the common flexure endpoint (e.g., common flexure endpoint 450 shown in FIG. 4A); a second elongated flexure (e.g., OMF 410 shown in FIG. 4A) of the OM flexure system; a first coupler (e.g., first coupler 340 shown in FIG. 10D) of the outer member 330; and a second outer gimbal coupler (e.g., outer gimbal coupler 1002A shown in FIG. 10D).

The novel flexure pivot 122A having the features and characteristics described herein can be fabricated using three-dimensional (3D) printing technology, which is also known as additive manufacturing and refers to a machine that fabricates a 3D physical object by using a printhead to successively form or deposit layers of material that will form a 3D physical object. The printhead operations are controlled by a computer that contains a 3D electronic model of the physical object. The 3D electronic model logically slices the physical object into several layers and provides instructions to the printhead for printing each layer. The instructions control the machine, and more specifically the printhead of the machine, to form/deposit each layer successively until the physical object is completed. The physical objects fabricated through 3D printing processes have a variety of shapes and geometries.

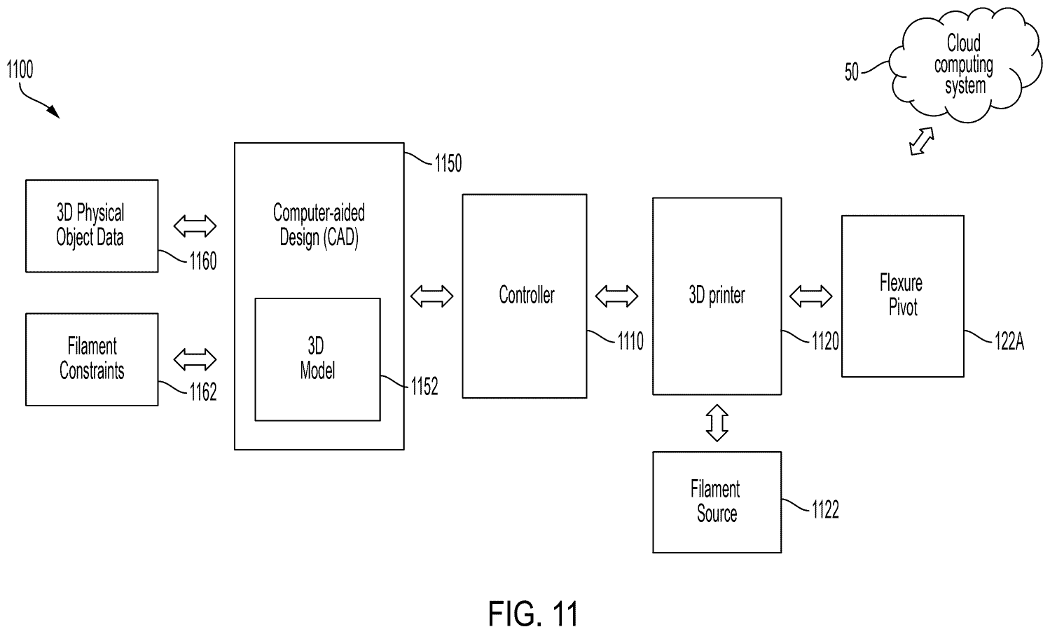

FIG. 11 depicts a simplified block diagram illustrating a system 1100 in accordance with embodiments of the disclosure. The system 1100 includes a controller 1110, a 3D printer 1120, a filament source 1122, and a CAD module 1150, configured and arranged as shown. In some embodiments of the disclosure, the 3D printer 1120 can be a 4D printer. In accordance with aspects of the disclosure, the controller 1110 is operable to load a 3D model 1152 from a model file of the CAD module 1150. In accordance with embodiments of the disclosure, the 3D model 1152 includes instructions operable to control a printhead 810 (shown in FIG. 8) and the filament source 1122 of the 3D printer 1120 to form/deposit a corresponding novel flexure pivot 122A.

The CAD module 1150 includes and executes CAD software. In general, CAD software is used by different types of engineers and designers to optimize and streamline the designer's workflow, increase productivity, improve the quality and level of detail in the design, improve documentation communications, and often contribute toward a manufacturing design database. CAD software outputs come in the form of electronic files, which are then used accordingly for manufacturing processes. The CAD software in the CAD module 1150 can further include computer-aided manufacturing (CAM) software that further assists with planning and executing the fabrication processes.

The CAD module 1150 includes a full range of CAD software functionality operable to design a 3D electronic model 1152 of a to-be-printed novel flexure pivot 122A based on 3D physical object data 1160 and filament constraints 252. In embodiments of the disclosure, the 3D physical object data 1160 and the filament constraints 1152 provide the size, dimensions, materials, etc. of the novel flexure pivot 122A to the CAD module 1150. In general, the filament constraints 1152 include various details on the size, number, dispersion density, and the like of the various components of the filaments that will be loaded into the filament source 1122 and used by the 3D printer 1120 to form the novel flexure pivot 122A. In accordance with aspects of the disclosure, the 3D model 1152 provides instructions to the printhead 810 and the filament source 1122, and the printhead 810 uses the instructions to build or print the novel flexure pivot 122A. The printhead 810 builds the novel flexure pivot 122A by depositing material onto a substrate known as a print bed or a print base (e.g., base 806 shown in FIG. 8). The printhead 810 can be configured to include a nozzle connected to the filament source 1122. The filament material provided to the printhead 810 by the filament source 1122 is extruded out the nozzle and onto a print base (e.g., base 806 shown in FIG. 8). The printhead 810 is governed by rules or instructions included in its corresponding 3D model 1152. The printhead 810 uses the information contained in its corresponding 3D model 1152 to determine how much material needs to be deposited and where, exactly, the material should be deposited.

Although the controller 1110, the 3D printer 1120, and the filament source 1122, are depicted as separate components, it is understood that the depicted components can be integrated with one another in any suitable combination. For example, the controller 1110 can be incorporated within the 3D printer 1120; and/or the filament source 1122 can be incorporated within the 3D printer 1120.

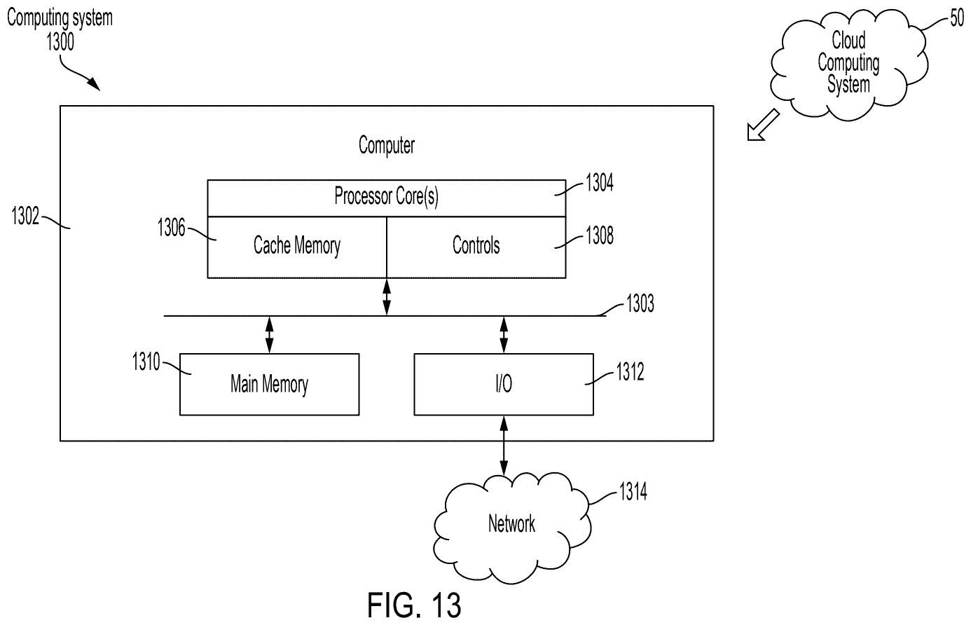

A cloud computing system 50 is in wired or wireless electronic communication with the system 1100. The cloud computing system 50 can supplement, support or replace some or all of the functionality of the various components of the system 1100. Additionally, some or all of the functionality of the system 1100 can be implemented as a node of the cloud computing system 50. Additional details of cloud computing features of embodiments of the disclosure are depicted by the computing environment 1300 shown in FIG. 13 and described in greater detail previously herein.

The novel flexure pivot 122A can be formed from any suitable material that provides the characteristics needed to perform the fine-compensation operations (including, specifically, flexure bending) described herein, including but not limited to steel materials, titanium materials, polymer materials, and combinations thereof. In embodiments of the disclosure where the flexure pivot 122A is a polymer material, the filaments in the filament source 1122 can be generated using a solution blending process to create an appropriate polymer blend. A polymer blend can refer to a blended mixture of two or more polymers. A polymer blend can also refer to a blended mixture of one or more polymers with other materials such as ceramics, carbon nanostructures or other fillers. The polymers can include, among other things, polylactic acid (PLA), acrylonitrile butadiene (ABS), polyethylene terephthalate glycol (PETG), polypropylene (PP), carbon fiber, nylon, high-impact polystyrene (HIPS), thermoplastic elastomers, or any other suitable polymer.

Polymer powder can be produced from the solution. For example, the solution can be cooled down from 80-100° C. to room-temperature to induce precipitation of polymer particles formed from polymer grains, separating the precipitate, drying and mechanical treatment (milling, grinding, chipping, etc.). The plastic (i.e., polymer) powder can be used to produce plastic pellets. The plastic pellets can be used to produce the filaments loaded into the filament source 1122. Filaments can also be produced directly from powder. It can be appreciated that substantially any technique, such as melt-blending, used for producing filaments from powders or pellets can be used. The filaments can be used for printing the novel flexure pivot 122A.

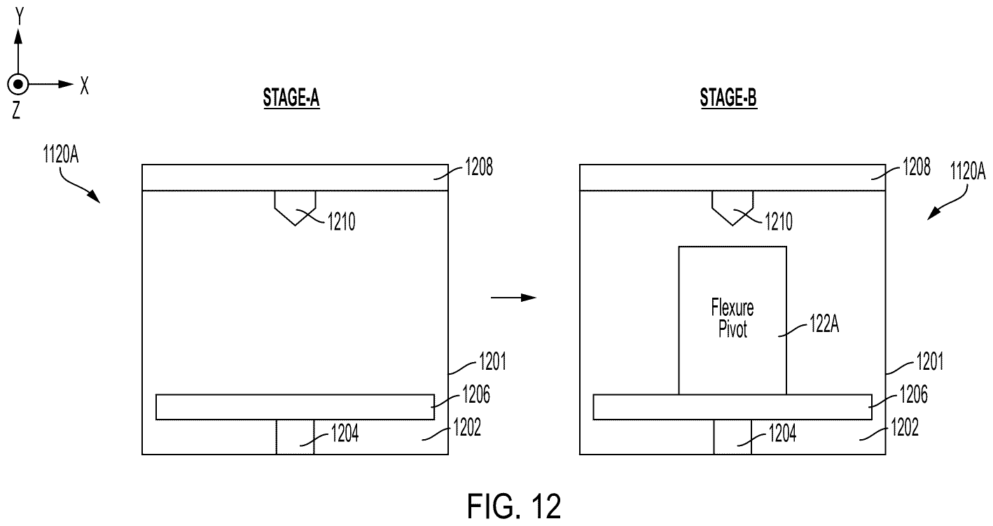

FIG. 12 depicts a combined system diagram and flow diagram illustrating a printing device and a computer-controlled fabrication method for forming the novel flexure pivot 122A in accordance with embodiments of the disclosure. More specifically, FIG. 11, depicts additional details of how the printer 1120 (shown in FIG. 11) can be implemented as a printer 1120A, and further illustrates a STAGE-A in which printing has not yet started, as well as a STAGE-B in which printing of the novel flexure pivot 122A has completed. At STAGE-A, the controller 1110 has accessed the 3D model 1152. FIG. 11 depicts a cross-sectional view of a portion of the printer 1120A in accordance with embodiments of the present disclosure. The printer 1120A includes a main body 1201 having an interior 1202. The interior 1202 houses a printhead assembly formed from a printhead support 1208 interconnected to a printhead 1210. The printhead assembly 1208/1210 is positioned above a print base 1206 that is interconnected to base support 1204.

The printer 1120A represents an automated manufacturing apparatus. In an embodiment of the present disclosure, the printer 1120A can be, for example, a 3D printer or a 4D printer. In embodiments of the disclosure, the printer 1120A can implement, for example, an additive manufacturing process such as fused filament fabrication in printing the novel flexure pivot 122A. The novel flexure pivot 122A can be a part, item, object, or the like. In embodiments of the disclosure, the printer 1120A may implement, for example, a spatial orientation and positioning system that can include control systems, actuators, sensors, hardware, and the like, to spatially orient and position the print assemblies 1210/1208 by way of the print base 1206. Spatial orientation and positioning of the print base 1206 or the printhead assemblies 1208/1210, or both, can occur along or about one or more of the X-, Y-, and Z-axes of a three-dimensional Cartesian coordinate system defined with respect to the printer 1120A. A closed loop control system can be implemented by the printer 1120A to actuate motors, such as DC stepper motors, to respectively orient and position the print bases 1206 or the printhead assemblies 1208/1210, or both, according to control data generated by encoders associated with the DC stepper motors under control of the novel flexure pivot 122A. The printer 1120A can include automated stereoscopic computer vision to monitor each printed layer during printing to ensure that an item such as the novel flexure pivot 122A prints correctly. Other spatial orientation and positioning systems can be used as a matter of design choice based on a particular application at-hand.

The printhead support 1208 represents part of the spatial orientation and positioning system of the printer 1120A used to support and spatially orient and position the printhead 1210 in printing the novel flexure pivot 122A. In embodiments of the disclosure, the printhead support 1208 can include, for example, a mount, carriage, chuck, or the like, to support and spatially orient and position one or more instances of the printhead 1210 within the interior 1202 of the printer 1120A. In embodiments of the disclosure, the printhead support 1208 can, for example, support its corresponding printhead 1210 for spatial orientation and positioning within interior 1202 along or about one or more of the X-, Y-, and Z-axes of the printer 1120A. In embodiments of the disclosure, the printhead support 1208 can include, for example, a translational stage such as a one-, two-, three-, four-, five-, or six-axis stage, or the like. For example, the printhead support 1208 can be formed of two one-axis stages, connected to effect two-axis stage functionality in operation, and so on. In embodiments of the disclosure, the printhead support 1208 can further include, for example, a linear bearing, rail, track, race, guide rod, or the like. For example, the printhead support 1208 can include a mount for receiving and supporting the printhead 1210, the mount being attached to one or more linear bearings, to effect spatial orientation and positioning of the printhead 1210 within the interior 1202 during operation of the printer 1120A.

The printhead 1210 represents an extruder of the printer 1120A used in printing the novel flexure pivot 122A. In embodiments of the disclosure, the printhead 1210 can be, for example, an extruder or the like. In embodiments of the disclosure, the printhead 1210 can implement, for example, an additive manufacturing process such as fused filament fabrication in printing the 3D physical object. During operation, the printhead 1210 receives or draws material, in the form of plastic or metallic filament, from a supply (e.g., the filament source 1122) for heating, melting, and extruding of the drawn material from nozzles of the printhead 1210. The extruded material is formed and deposited in layers on or along a corresponding surface of a corresponding print bases 1206 to form the printed novel flexure pivot 122A. In embodiments of the disclosure, the extruded material can include, for example, plastic material such as acrylonitrile butadiene styrene (ABS), polylactic acid (PLA), high-impact polystyrene (HIPS), thermoplastic polyurethane (TPU), aliphatic polyamides (nylon), polypropylene (PP), polyetherimide (PEI), polyether ether ketone (PEEK), acrylonitrile styrene acrylate (ASA), polycarbonate (PC), polyethylene terephthalate (PET), polyoxymethylene (POM), polyvinyl alcohol (PVA), or the like. In embodiments of the disclosure, the extruded material may otherwise include wood fill material, metallic material, conductive material, or the like.

At STAGE-B, the print base 1206 represents a build surface used by the printer 1120A to deposit extruded material for support in printing the novel flexure pivot 122A. In embodiments of the present disclosure, the print base 1206 can be or include, for example, a print bed, build plate, platform, table, board, sheet, laminate, or the like. A top surface of the print base 1206 receives and supports extruded material deposited by a corresponding printhead 1210 in printing the novel flexure pivot 122A. A size or surface area of the print bases 1206, such as with respect to the top surface, can be chosen according to a size of an item to be printed, such as the novel flexure pivot 122A.

The base support 1204 represents part of the spatial orientation and positioning system of the printer 1120A used to support and spatially orient and position the base assemblies 1204/1206 in printing the novel flexure pivot 122A. In embodiments of the disclosure, the base support 1204 can be, for example, a robotic arm, or the like. In embodiments of the disclosure, the base support 1204 can include, for example, a platform, mount, carriage, chuck, end effector, or the like, to attach to, support and spatially orient and position the base assembly 1206 within, or inside, outside, and about the interior 1202 of the printer 1120A. The robotic arm can include stereoscopic computer vision. In embodiments of the disclosure, the base support 1204 can, for example, support the base assembly 1206 for spatial orientation and positioning within, outside, and about the interior 1202 along or about one or more of the X-, Y-, and Z-axes of the printer 1120A. In embodiments of the disclosure, upon completion of printing, the base support 1204 can move the base assembly for detachment of the novel flexure pivot 122A from the base assembly 1206. In embodiments of the disclosure, the base support 1204 can be, for example, a conveyor belt, or the like.

FIG. 13 illustrates an example of a computer system 1300 that can be used to implement the computer-based components in accordance with aspects of the disclosure. The computer system 1300 includes an exemplary computing device (“computer”) 1302 configured for performing various aspects of the content-based semantic monitoring operations described herein in accordance aspects of the disclosure. In addition to computer 1302, exemplary computer system 1300 includes network 1314, which connects computer 1302 to additional systems (not depicted) and can include one or more wide area networks (WANs) and/or local area networks (LANs) such as the Internet, intranet(s), and/or wireless communication network(s). Computer 1302 and additional system are in communication via network 1314, e.g., to communicate data between them.

Exemplary computer 1302 includes processor cores 1304, main memory (“memory”) 1310, and input/output component(s) 1312, which are in communication via bus 1303. Processor cores 1304 includes cache memory (“cache”) 1306 and controls 1308, which include branch prediction structures and associated search, hit, detect and update logic, which will be described in more detail below. Cache 1306 can include multiple cache levels (not depicted) that are on or off-chip from processor 1304. Memory 1310 can include various data stored therein, e.g., instructions, software, routines, etc., which, e.g., can be transferred to/from cache 1306 by controls 1308 for execution by processor 1304. Input/output component(s) 1312 can include one or more components that facilitate local and/or remote input/output operations to/from computer 1302, such as a display, keyboard, modem, network adapter, etc. (not depicted).

A cloud computing system 50 is in wired or wireless electronic communication with the computer system 1300. The cloud computing system 50 can supplement, support or replace some or all of the functionality (in any combination) of the computer system 1300. Additionally, some or all of the functionality of the computer system 1300 can be implemented as a node of the cloud computing system 50.

For the sake of brevity, conventional techniques related to making and using aspects of the disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Similarly, conventional techniques related to device fabrication operations may or may not be described in detail herein. Moreover, the various tasks and process steps described herein can be incorporated into a more comprehensive procedure or process having additional steps or functionality not described in detail herein. In particular, various steps in the manufacture of devices described herein are well known and so, in the interest of brevity, many conventional steps will only be mentioned briefly herein or will be omitted entirely without providing the well-known process details.

Some functional units of the systems described in this specification can be labeled as modules. Embodiments of the disclosure apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

The various components/modules/models of the systems illustrated herein are depicted separately for ease of illustration and explanation. In embodiments of the disclosure, the functions performed by the various components/modules/models can be distributed differently than shown without departing from the scope of the various embodiments of the disclosure describe herein unless it is specifically stated otherwise.

Various embodiments of the disclosure are described herein with reference to the related drawings. Alternative embodiments of the disclosure can be devised without departing from the scope of this disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value. Additionally, the terms “about,” “substantially,” “approximately,” and variations thereof, refer to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

Aspects of the disclosure can be embodied as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the claims.

What is claimed is:

1. A structure operable to perform compensation movements, the structure comprising:
a flexure system comprising:
an outer member (OM) flexure system associated with an outer member; and
an inner member (IM) flexure system associated with an inner member;
wherein the OM flexure system comprises OM flexures having first OM flexure endpoints;
wherein the IM flexure system comprises IM flexures having first IM flexure endpoints; and
a common flexure endpoint comprising the first IM flexure endpoints co-located with the first OM flexure endpoints;
wherein the IM flexures comprise a first IM flexure mechanically coupled to the inner member;
wherein the OM flexures comprise a first OM flexure mechanically coupled to the outer member; and
wherein the compensation movements comprise the inner member and the outer member moving with respect to one another.

2. The structure of claim 1, wherein the compensation movements comprise a rotation.

3. The structure of claim 1, wherein the compensation movements comprise translational movements.

4. The structure of claim 1, wherein the compensation movements comprise vibration movements.

5. The structure of claim 1, wherein:
the outer member comprises an OM cavity;
the inner member comprises an IM cavity; and
the inner member is at least partially within the OM cavity.

6. The structure of claim 5, wherein:
the inner member comprises an IM platonic shape having corners;
the corners comprises a first IM corner; and
the first IM flexure is mechanically coupled to the inner member at the first IM corner.

7. The structure of claim 6, wherein:
the outer member comprises an OM substantially spherical shape having an OM inner surface and OM openings extending through the OM inner surface;
the OM inner face comprises a first OM inner face region; and
the first OM flexure is mechanically coupled to the outer member at the first OM inner face region.

8. The structure of claim 1, wherein the structure comprises a no-movement position and movement positions.

9. The structure of claim 8, wherein:
the no-movement position is based at least in part on:
no movement force applied to the structure;
substantially no bending in the OM flexures; and
substantially no bending in the IM flexures; and
the movement positions are based at least in part on:
a movement force applied to the structure;
bending in the OM flexures; and
bending in the IM flexures.

10. The structure of claim 9, wherein:
the outer member comprises at least one OM opening extending through the output member; and
the movement positions are restricted by the at least one OM opening.

11. A structure operable to perform compensation movements, the structure comprising:
an outer member comprising:
a substantially spherical shape; and
an outer member (OM) cavity;
an inner member comprising:
a substantially platonic shape having inner member (IM) corners; and
an IM cavity;
wherein the inner member is at least partially within the OM cavity;
wherein the compensation movements comprise the inner member and the outer member moving with respect to one another;
a flexure system comprising:
an OM flexure system mechanically coupled to the outer member; and
an IM flexure system mechanically coupled to the inner member;
wherein the OM flexure system comprises OM flexures having first OM flexure endpoints;
wherein the IM flexure system comprises IM flexures having first IM flexure endpoints; and
a common flexure endpoint comprising the first IM flexure endpoints co-located with the first OM flexure endpoints;
wherein the OM flexures comprise a first OM flexure;
wherein the OM flexure system mechanically coupled to the outer member comprises the first OM flexure mechanically coupled to the outer member;
wherein the IM corners comprise a first IM corner;
wherein the IM flexures comprise a first IM flexure; and
wherein the IM flexure system mechanically coupled to the inner member comprises the first IM flexure mechanically coupled to the first IM corner.

12. The structure of claim 11, wherein the compensation movements are selected from the group consisting of a rotation, a translation, and a vibration.

13. The structure of claim 11, wherein the substantially spherical shape comprises an OM inner face and OM openings extending through the OM outer member.

14. The structure of claim 13, wherein:
the OM inner face comprises a first OM inner face region; and
the first OM flexure is mechanically coupled to the outer member at the first OM inner face region.

15. The structure of claim 11, wherein:
the structure comprises a no-movement position and movement positions;
the no-movement position is based at least in part on:
no movement force applied to the structure;
substantially no bending in the OM flexures; and
substantially no bending in the IM flexures; and
the movement positions are based at least in part on:
a movement force applied to the structure;
bending in the OM flexures; and
bending in the IM flexures;
the outer member comprises at least one OM opening extending through the output member; and
the movement positions are restricted by the at least one OM opening.

16. A method of forming a structure operable to perform compensation movements, the method comprising using an additive manufacturing device to perform additive manufacturing operations comprising:
forming a flexure system comprising:
an outer member (OM) flexure system associated with an outer member; and
an inner member (IM) flexure system associated with an inner member;
wherein the OM flexure system comprises OM flexures having first OM flexure endpoints;
wherein the IM flexure system comprises IM flexures having first IM flexure endpoints; and
forming a common flexure endpoint comprising the first IM flexure endpoints co-located with the first OM flexure endpoints;
wherein the IM flexures comprise a first IM flexure mechanically coupled to the inner member;
wherein the OM flexures comprise a first OM flexure mechanically coupled to the outer member; and
wherein the compensation movements comprise the inner member and the outer member moving with respect to one another.

17. The method of claim 16, wherein:
the outer member comprises an OM cavity;
the inner member comprises an IM cavity;
the inner member is at least partially within the OM cavity;
the inner member comprises an IM platonic shape having corners;
the corners comprises a first IM corner;
the first IM flexure is mechanically coupled to the inner member at the first IM corner;
the outer member comprises an OM substantially spherical shape having an OM inner surface and OM openings extending through the OM inner surface;
the OM inner face comprises a first OM inner face region; and
the first OM flexure is mechanically coupled to the outer member at the first OM inner face region.

18. The method of claim 16, wherein the structure comprises a no-movement position and movement positions.

19. The method of claim 18, wherein:
the no-movement position is based at least in part on:
no movement force applied to the structure;
substantially no bending in the OM flexures; and
substantially no bending in the IM flexures; and
the movement positions are based at least in part on:
a movement force applied to the structure;
bending in the OM flexures; and
bending in the IM flexures.

20. The method of claim 19, wherein:
the outer member comprises at least one OM opening extending through the output member; and
the movement positions are restricted by the at least one OM opening.
